(19) United States
(12) Patent Application Publication
(10) Pub. No.: US 2026/0350640 A1
(43) Pub. Date: Nov. 5, 2026

(54) USER CONSENT PREFERENCES AND BROWSER TAG HANDLING SYSTEM

(71) Applicant: Nessa Labs, Inc. (dba MetaRouter), Broomfield, CO (US)

(72) Inventors: Gregory Brunk, Fort Collins, CO (US); Andrew Murray, Covington, KY (US); Michael Yeager, Arvada, CO (US)

(21) Appl. No.: 19/734,189

(22) Filed: Jul. 8, 2026

Related U.S. Application Data
(63) Continuation of application No. 19/177,274, filed on Apr. 11, 2025.
(60) Provisional application No. 63/632,938, filed on Apr. 11, 2024.
(60) Provisional application No. 63/718,010, filed on Nov. 8, 2024.
(60) Provisional application No. 63/752,405, filed on Jan. 31, 2025.

(51) Int. Cl. G06Q 30/0201; G06F 21/62

(52) U.S. Cl. CPC G06Q 30/0201; G06F 21/6263

(57) ABSTRACT

The disclosure includes system and method embodiments for website tag behavior, including consolidating the behavior and tracking activities of tags, eliminating tags, making the process more streamlined, using fewer browser and server resources, and providing standardized or more convenient collection and formatting of browser information, user identifiers, and interaction data. Users may experience faster load times when visiting websites. Website owners may have more control over data collected during visits to their websites. The owners’ servers and user’s browsers may be more efficiently used for transmission of data. Embodiments can also provide future proof of data collection and distribution by allowing for server-side data distribution and highly controlled and transparent identity management to prevent signal loss in a cookie-less world.

### CROSS REFERENCE TO RELATED INFORMATION

This application claims the benefit of United States of America priority application No. 63/632,938 filed on Apr. 11, 2024, titled “Identity Syncing and Data Collection,” as well as United States of America priority application No. 63/718,010 filed on Nov. 8, 2024, titled “Sync Injector,” as well as United States of America priority application No. 63/752,405 filed on Jan. 31, 2025, titled “Consent Enforcement Workflow,” the contents of all of which are hereby incorporated herein in their entirety.

### TECHNICAL FIELD

The present disclosure generally relates to methods and systems for creating one or more tracking tools for use in an internet browser.

### BACKGROUND

There are a multitude of tracking technologies in use on the internet. The use of tags and cookies to track user behavior is well known. A given company may have various accounts that are all tracking their users’ behavior. For instance, a single user may be tracked by Google^{TM}, Meta^{TM}, Tiktok^{TM}, X^{TM}/Twitter^{TM}, and other accounts. Each of these parties may load a tag within the websites the user visits to track their online history and collect data about pages visited, items purchased, and more. While users give up their own data during these exchanges, so do websites. A user might visit burger-co.com, for example. During that visit Burger-Co’s website tags are tracking the user’s usage of the website, data that Home Depot and the user may want better controlled. Data collection by multiple browser tags can slow down Burger-Co’s website during a visit and expose data to 3^{rd}-parties unnecessarily, reflecting poorly on Burger-Co in the mind of consumers and affecting the user’s likelihood to further engage (e.g., browse products, purchase, etc.).

### SUMMARY

One embodiment under the present disclosure comprises a computer implemented method of creating one or more tracking tools for use in an internet browser. The method comprises: receiving, from a client user, identification of one or more consent categories; receiving, from the client user, identification of one or more domains for cross-domain syncing; receiving, from the client user, one or more secure PII configurations; receiving, from the client user, identification of one or more sync injector templates for use in the client user’s website; receiving, from the client user, one or more sync-specific configurations to apply to the one or more sync injector templates; compiling the one or more sync-specific configurations, one or more consent categories, one or more domains, and one or more secure PII, configurations to the one or more sync injector template to create a respective one or more compiled sync injectors; storing the one or more compiled sync injectors in one or more libraries; and transmitting the one or more compiled sync injectors to one or more website servers.

Another embodiment comprises a system for creating one or more tracking tools for use in an internet browser, comprising: processing circuitry; and a memory. The memory containing instructions executable by the processing circuitry whereby the system is operative to: receive, from a client user, identification of one or more consent categories; receive, from the client user, identification of one or more domains for cross-domain syncing; receive, from the client user, one or more secure PII, configurations; receive, from the client user, identification of one or more sync injector templates for use in the client user’s website; receive, from the client user, one or more sync-specific configurations to apply to the one or more sync injector templates; compile the one or more sync-specific configurations, one or more consent categories, one or more domains, and one or more secure PII configurations to the one or more sync injector template to create a respective one or more compiled sync injectors; store the one or more compiled sync injectors in one or more libraries; and transmit the one or more compiled sync injectors to one or more website servers.

Another embodiment comprises a computer implemented method of creating one or more tracking tools for use in an internet browser. The method comprises: receiving one or more new sync injector configurations; compiling the one or more new sync injector configurations into one or more predefined sync structures to create a respective one or more new formatted sync injectors; and storing the one or more new formatted sync injectors in a customer specific library.

Another embodiment comprises a system for creating one or more tracking tools for use in an internet browser, comprising: processing circuitry and a memory. The memory containing instructions executable by the processing circuitry whereby the system is operative to: receive one or more new sync injector configurations; compile the one or more new sync injector configurations into one or more predefined sync structures to create a respective one or more new formatted sync injectors; and store the one or more new formatted sync injectors in a customer specific library.

Another embodiment comprises a computer implemented method for enforcing user consent preferences related to one or more tracking tools for use in an internet browser. The method comprises: receiving, from a client user, identification of one or more consent categories; presenting, to a browsing user, the one or more consent categories; receiving, from the browsing user, one or more preferences for the one or more consent categories; tracking one or more browser events related to activity of the browsing user on a website; combining the one or more preferences to the one or more browser events.

Another embodiment comprises a system for enforcing user consent preferences related to one or more tracking tools for use in an internet browser. The system comprises processing circuitry and a memory. The memory containing instructions executable by the processing circuitry whereby the system is operative to perform the steps of: receiving, from a client user, identification of one or more consent categories; presenting, to a browsing user, the one or more consent categories; receiving, from the browsing user, one or more preferences for the one or more consent categories; tracking one or more browser events related to activity of the browsing user on a website; and combining the one or more preferences to the one or more browser events.

Another embodiment comprises a computer implemented method for enforcing user consent preferences related to one or more tracking tools for use in an internet browser of a business. The method comprises: receiving one or more preferences of a browsing user related to tracking data; storing the one or more preferences in the browser; configuring whether implicit mode or explicit mode is applicable to the business’s compliance settings; if implicit mode is applicable, then performing the steps of; executing syncs unless the browsing user opts out of tracking one or more categories; and if a browsing user has opted out of a category, then not executing the sync; and if explicit mode is applicable, then performing the steps of; only executing syncs once the browsing user opts in to tracking one or more categories; and if a browsing user has opted out of a category, then not executing the sync.

Another embodiment comprises a system for enforcing user consent preferences related to one or more tracking tools for use in an internet browser. The system comprises processing circuitry and a memory. The memory containing instructions executable by the processing circuitry whereby the system is operative to perform the steps of: receiving one or more preferences of a browsing user related to tracking data; storing the one or more preferences in the browser; detecting whether implicit mode or explicit mode is applicable to the browsing user; if implicit mode is applicable, then performing the steps of; executing syncs unless the browsing user opts out of tracking one or more categories; and if a browsing user has opted out of a category, then not executing the sync; and if explicit mode is applicable, then performing the steps of; only executing syncs once the browsing user opts in to tracking one or more categories; and if a browsing user has opted out of a category, then not executing the sync.

Another embodiment comprises a computer implemented method for tracking cross-domain user identifications. The method comprises: collecting one or more user identifications, each of the one or more user identifications identifying a user with respect to one or more online services; associating the one or more user identifications with one or more DNS, addresses associated with the one or more online services; sending a request, to the one or more DNS addresses, for additional data related to the one or more user identifications; receiving the additional data; and combining the additional data with the one or more user identifications.

Another embodiment comprises a system for tracking cross-domain user identifications, comprising processing circuitry and a memory. The memory containing instructions executable by the processing circuitry whereby the system is operative to perform the steps of: collecting one or more user identifications, each of the one or more user identifications identifying a user with respect to one or more online services; associating the one or more user identifications with one or more DNS, addresses associated with the one or more online services; sending a request, to the one or more DNS addresses, for additional data related to the one or more user identifications; receiving the additional data; and combining the additional data with the one or more user identifications.

Another embodiment comprises a computer implemented method for enriching one or more hashed user identifications of a user visiting a website. The method comprises: detecting one or more user identifications of the user; transmitting a request to a secure PII endpoint for one or more additional data related to the one or more user identifications; receiving the one or more additional data, the one or more additional data comprising PII; hashing the one or more additional data; and combining the hashed one or more additional data with one or more records of the user’s visit to the website.

Another embodiment comprises a system for enriching one or more hashed user identifications of a user visiting a website, comprising: processing circuitry and a memory. The memory containing instructions executable by the processing circuitry whereby the system is operative to perform the steps of: detecting one or more user identifications of the user; transmitting a request to a secure PII endpoint for one or more additional data related to the one or more user identifications, the one or more additional data comprising PII; receiving the one or more additional data; hashing the one or more additional data; and combining the hashed one or more additional data with one or more records of the user’s visit to the website.

Another embodiment comprises a computer implemented method for tracking user behavior at a website. The method comprises: detecting one or more online identifiers for the user; storing the one or more online identifiers within the user’s browser; running an analytics library, the analytics library configured to track one or more user events with respect to the website, the analytics library further configured to format the one or more user events for use by one or more online entities related to the one or more online identifiers, each of the one or more online entities related to one or more vendor identifiers; generating, by the analytics library, the one or more user events; injecting, by the analytics library, the one or more vendor identifiers into each of the one or more user events; and transmitting each of the formatted one or more user events to each respective of the one or more online entities.

Another embodiment comprises a system for tracking user behavior at a website, comprising: processing circuitry and a memory. The memory containing instructions executable by the processing circuitry whereby the system is operative to perform the steps of: detecting one or more online identifiers for the user; storing the one or more online identifiers within the user’s browser; running an analytics library, the analytics library configured to track one or more user events with respect to the website, the analytics library further configured to format the one or more user events for use by one or more online entities related to the one or more online identifiers, each of the one or more online entities related to one or more vendor identifiers; generating, by the analytics library, the one or more user events; injecting, by the analytics library, the one or more vendor identifiers into each of the one or more user events; and transmitting each of the formatted one or more user events to each respective of the one or more online entities.

Another embodiment comprises a computer implemented method of managing one or more tracking tools in a browser. The method comprises: receiving, at a website server, a request from a browser for one or more website pages comprising the website, the one or more website pages comprising a tag configured to load a cookie onto the browser, the cookie comprising an identity graph comprising one or more entries for one or more identifiers associated with a user of the browser for one or more marketing partners, the cookie defining a data format; detecting, by the tag, one or more cookie data associated with the one or more marketing partners and identifying the user; requesting, from the one or more marketing partners, the one or more identifiers to place in the one or more entries of the cookie; loading, by the website server, the cookie onto the browser; collecting, by the cookie, one or more activities of the user on the one or more website pages; transmitting the one or more activities, enriched with the previously collected identity graph stored as cookies, to one or more identity servers according to the data format; associating, by the one or more identity servers, the one or more activities with an event format associated with each of the one or more marketing partners; and forwarding the one or more activities to the one or more marketing partners according to the respective event format.

Another embodiment comprises a system for managing one or more tracking tools in a browser, comprising: processing circuitry; and a memory. The memory containing instructions executable by the processing circuitry whereby the system is operative to perform the steps of: receiving, at a website server, a request from a browser for one or more website pages comprising the website, the one or more website pages comprising a tag configured to load a cookie onto the browser, the cookie comprising an identity graph comprising one or more entries for one or more identifiers associated with a user of the browser for one or more marketing partners, the cookie defining a data format; detecting, by the tag, one or more cookie data associated with the one or more marketing partners and identifying the user; requesting, from the one or more marketing partners, the one or more identifiers to place in the one or more entries of the cookie; loading, by the website server, the cookie onto the browser; collecting, by the cookie, one or more activities of the user on the one or more website pages; transmitting the one or more activities, enriched with the previously collected identity graph stored as cookies, to one or more identity servers according to the data format; associating, by the one or more identity servers, the one or more activities with an event format associated with each of the one or more marketing partners; and forwarding the one or more activities to the one or more marketing partners according to the respective event format.

Another embodiment comprises a method performed by one or more web servers for providing a website to users. The method comprises: receiving a request from a browser for one or more website pages comprising a website, the one or more website pages comprising a tag configured to load a cookie onto the browser, the cookie comprising an identity graph comprising one or more entries for one or more identifiers associated with a user of the browser for one or more marketing partners, the cookie defining a data format; detecting one or more cookie data associated with the one or more marketing partners and identifying the user; requesting, from the one or more marketing partners, the one or more identifiers to place in the one or more entries of the cookie; loading the cookie onto the browser, wherein the cookie is configured to; collect one or more activities of the user on the one or more website pages; and transmit the one or more activities to one or more tag/identity servers according to the data format.

Another embodiment comprises one or more web servers configured to provide a website to users, comprising processing circuitry; power supply circuitry configured to supply power to the processing circuitry; and a memory. The memory containing instructions executable by the processing circuitry whereby the one or more web servers are operative to: receive a request from a browser for one or more website pages comprising a website, the one or more website pages comprising a tag configured to load a cookie onto the browser, the cookie comprising an identity graph comprising one or more entries for one or more identifiers associated with a user of the browser for one or more marketing partners, the cookie defining a data format; detect one or more cookie data associated with the one or more marketing partners and identifying the user; request, from the one or more marketing partners, the one or more identifiers to place in the one or more entries of the cookie; load the cookie onto the browser, wherein the cookie is configured to; collect, by the cookie, one or more activities of the user on the one or more website pages; transmit the one or more activities to one or more tag/identity servers according to the data format.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of a tag and identity data collection and syncing system under the present disclosure;

FIG. 2 illustrates certain aspects of the example system embodiment shown in FIG. 1;

FIG. 3 illustrates certain aspects of the example system embodiment shown in FIG. 1;

FIG. 4 illustrates certain aspects of the example system embodiment shown in FIG. 1;

FIG. 5 illustrates certain aspects of the example system embodiment shown in FIG. 1;

FIG. 6 illustrates an embodiment of a tag and identity syncing system under the present disclosure;

FIG. 7 illustrates an embodiment of a tag or sync injector under the present disclosure;

FIG. 8 shows an example embodiment of a computing device under the present disclosure;

FIG. 9 shows a flow chart of a method embodiment under the present disclosure;

FIG. 10 illustrates one embodiment of a tag and identity data collection and syncing system under the present disclosure;

FIG. 11 illustrates certain aspects of the example system embodiment shown in FIG. 10;

FIG. 12 illustrates certain aspects of the example system embodiment shown in FIG. 10;

FIG. 13 illustrates certain aspects of the example system embodiment shown in FIG. 10;

FIG. 14 illustrates certain aspects of the example system embodiment shown in FIG. 10;

FIG. 15 illustrates certain aspects of the example system embodiment shown in FIG. 10;

FIG. 16 shows a flow chart of a method embodiment under the present disclosure;

FIG. 17 shows a flow chart of a method embodiment under the present disclosure;

FIG. 18 shows a flow chart of a method embodiment under the present disclosure.

FIG. 19 shows a flow chart of a method embodiment under the present disclosure;

FIG. 20 shows a flow chart of a method embodiment under the present disclosure;

FIG. 21 shows a flow chart of a method embodiment under the present disclosure;

FIG. 22 shows a flow chart of a method embodiment under the present disclosure;

FIG. 23 shows a flow chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges to the handling of internet browser tags and other tracking technologies. A given user may have 10 or more cookies identifying them within downstream systems. And a given website may have 10 or more tags collecting user activity on the website, including those cookies. For example, a given website (website.com) may have marketing partnerships with e.g., Google, Meta, and others. Each marketing partner may install a tag on the website, and each tag may load software/cookies onto a user’s browser during their visit to website.com. If each tag is collecting and transmitting data when the user visits a website, this can slow down the user’s visit and their browser, possibly reflecting badly on the website owner and hurting their conversion rates. The website owner may also wish to prevent any fraudulent, disruptive, or unintended activity occurring as a result of a tag’s behavior on a user’s browser. The website owner may also wish to extract the maximum value from website interactions, through accurate reporting of data to maximize its own commercial relationships with advertisers and other third parties. This can be difficult if multiple tags are running on a user’s browser and each collecting unique data in unique formats. It is also challenging to ensure that each tag or cookie is complying with data privacy preferences by users and/or legal statutes prohibiting certain types of tracking or data collection.

Certain aspects of the embodiments disclosed herein provide solutions to these or other challenges. Embodiments include systems and methods for consolidating the behavior and tracking activities of tags, eliminating tags, making the process more streamlined, using fewer browser and server resources, and providing standardized or more convenient collection and formatting of browser information, user identifiers, and interaction data.

Certain embodiments may provide one or more of the following technical advantages. Users may experience faster load times when visiting websites. Website owners may have more control over data collected during visits to their websites. The owners’ servers and user’s browsers may be more efficiently used for transmission of data. Embodiments can also provide future proof of data collection and distribution by allowing for server-side data distribution and highly controlled and transparent identity management to prevent signal loss in a cookie-less world. Embodiments can also provide anonymous, first-party identify resolution. This can yield a company owned first party identity graph in the browser enabling anonymous user engagement and improved signal data. Another benefit can be improved data governance and compliance. This includes the ability to control how and what data is collected and what data is shared all within your infrastructure. Benefits for e-commerce and digital teams include improved site performance and faster deployments, with increased conversions, faster time to value for new technologies, and increased operational efficiency. Benefits for marketing teams include larger targetable audiences for marketing campaigns, cross-domain tracking and coordination, and persistent identity tracking. This can lead to increased returns on assets (ROA), reduced data onboarding costs and increased sales. Benefits for IT and infosec teams include improved data security and improved regulatory compliance, leading to reduced security vulnerabilities and reduced risk of regulatory fines.

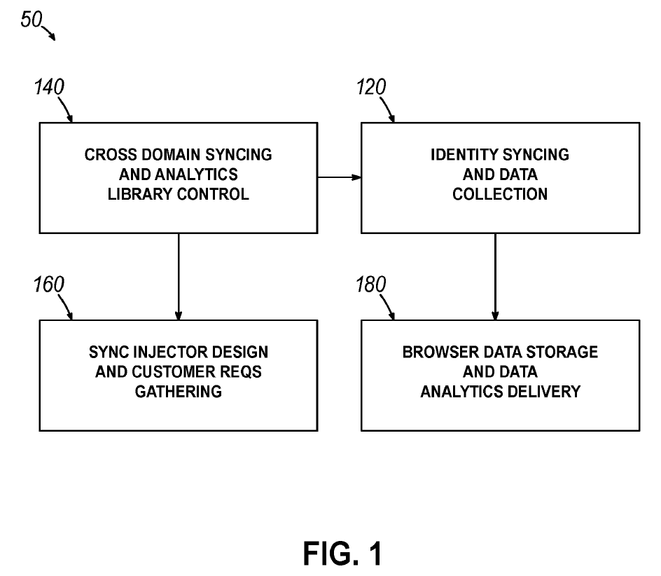

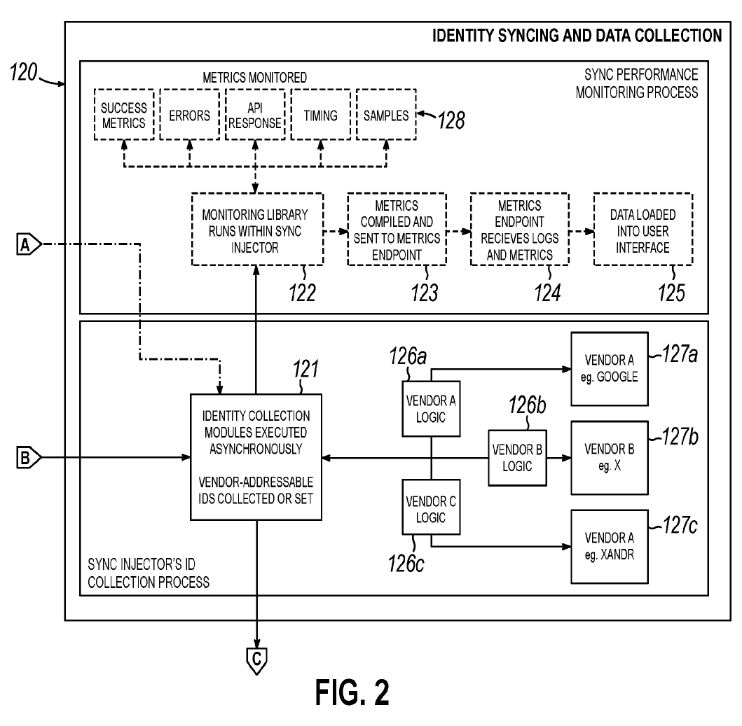

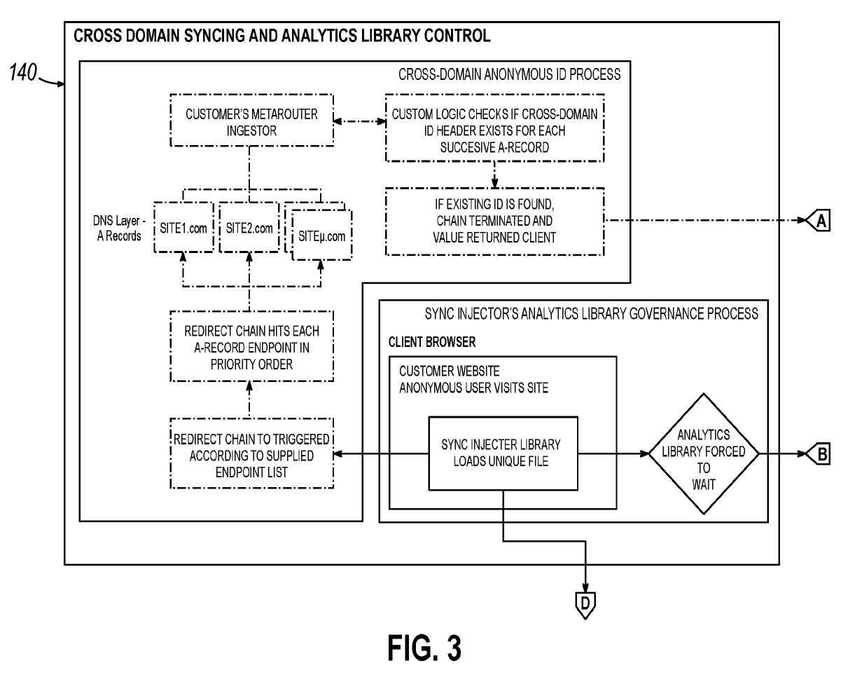

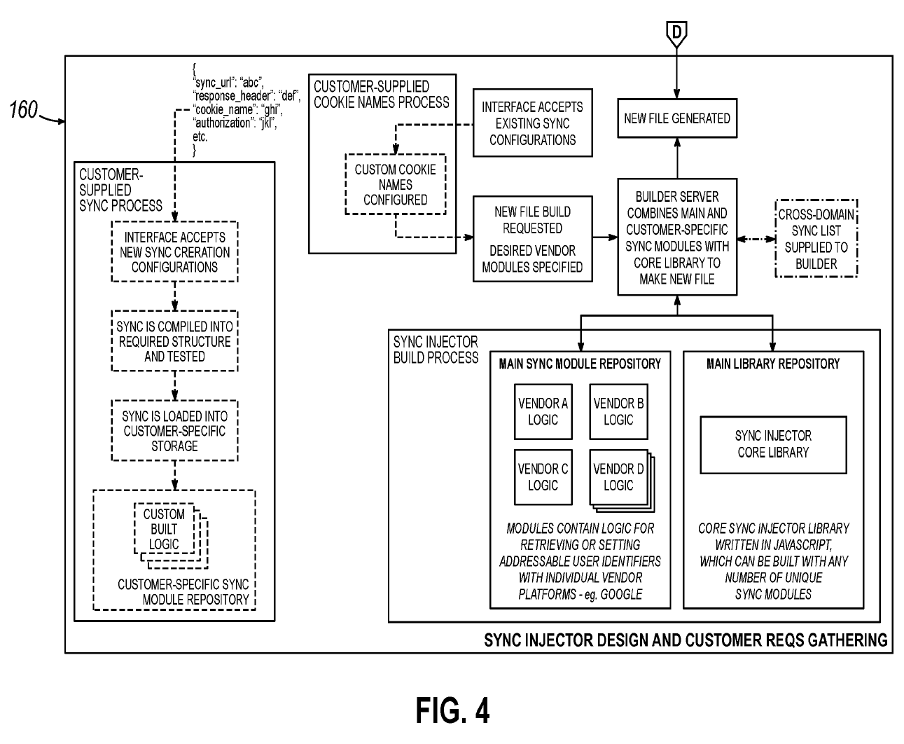

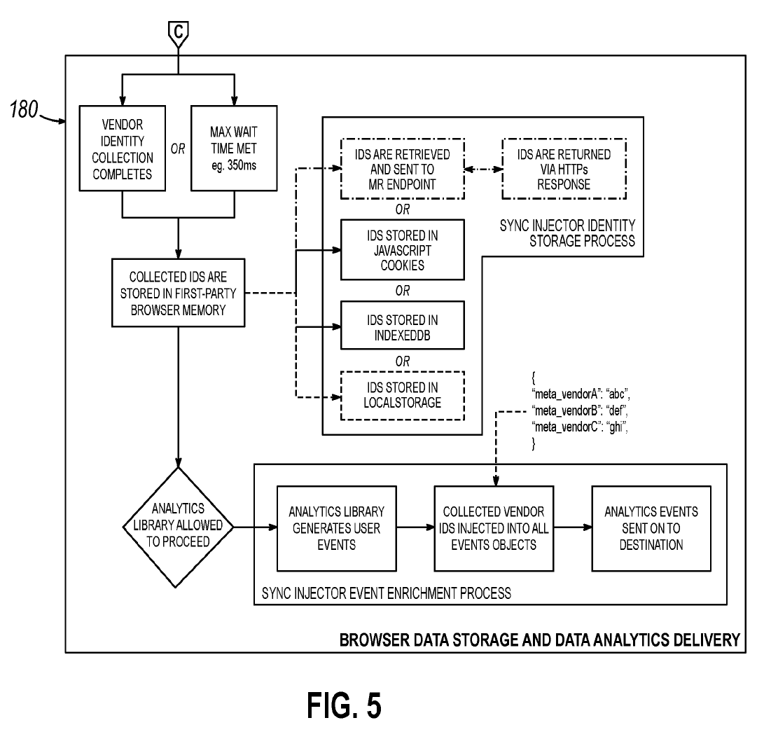

FIG. 1 displays one embodiment of a browser tag handling and identity tracking system 50 under the present disclosure. Functionalities include the handling or consolidation of browser tag and user tracking capabilities as well as identity tracking and syncing across browsers, websites and tracking systems. Portions of FIG. 1 include: cross domain syncing and analytics library control 140 (and see FIG. 3); identity syncing and data collection 120 ( and see FIG. 2); sync injector design and customer requirements gathering 160 (and see FIG. 4)); and browser data storage and data analytics delivery 180 (and see FIG. 5). Embodiments under the present disclosure include a variety of sub-systems and sub-methods within system 50 and its associated method embodiments. Embodiments under the present disclosure include those labeled as portions within system 50, including:
Sync injector design and customer requirements gathering, highlighted by e.g., FIG. 4, and other embodiments herein;
Sync injector analytics library governance systems and methods, highlighted by e.g., FIG. 3, and other embodiments herein;
Sync injector ID collection systems and methods, highlighted by e.g., FIG. 2, and other embodiments herein;
Sync injector ID storage systems and methods, highlighted in e.g., FIG. 5, and other embodiments herein;
Sync injector event enrichment systems and methods, highlighted in e.g., FIG. 5, and other embodiments herein;
Customer supplied cookie names systems and methods, highlighted by e.g., FIG. 4, and other embodiments herein;
Customer supplied sync systems and methods, highlighted by e.g, FIG. 4, and other embodiments herein;
Cross-domain anonymous ID systems and methods, highlighted by e.g., FIG. 3, and other embodiments herein;
Sync performance monitoring systems and methods, highlighted by e.g., FIG. 2, and other embodiments herein.

The various portions of FIG. 1, and the respective embodiments can further be grouped roughly into the following four groups (noting that there is some overlap and interaction between the illustrated elements):
Identity Syncing and Data Collection 120, see FIG. 2, deal with data collection and monitoring of the collection process, and as described in further detail below;
Browser Data Storage and Data Analytics Delivery 140, see FIG. 3, these aspects generally deal with information collected and storing it in the browser as well as other data analytics;
Cross Domain Syncing and Analytics Library Control 160, see FIG. 4, these aspects generally deal with syncing across various domains and control of the analytics library; and
Sync Injector Design and Customer Requirements Gathering 180, see FIG. 5, these aspects generally deal with allowing website managers to arrange who they want to interact with through their tags and data collection activities.

There is some overlap between the functionalities displayed in FIGS. 2-5. The borders between the figures are not rigid, as some functionality extends or interacts with aspects of the neighboring figure.

Further disclosure is given below, with particular focus on FIG. 2 and Identity Syncing and Data Collection 120.

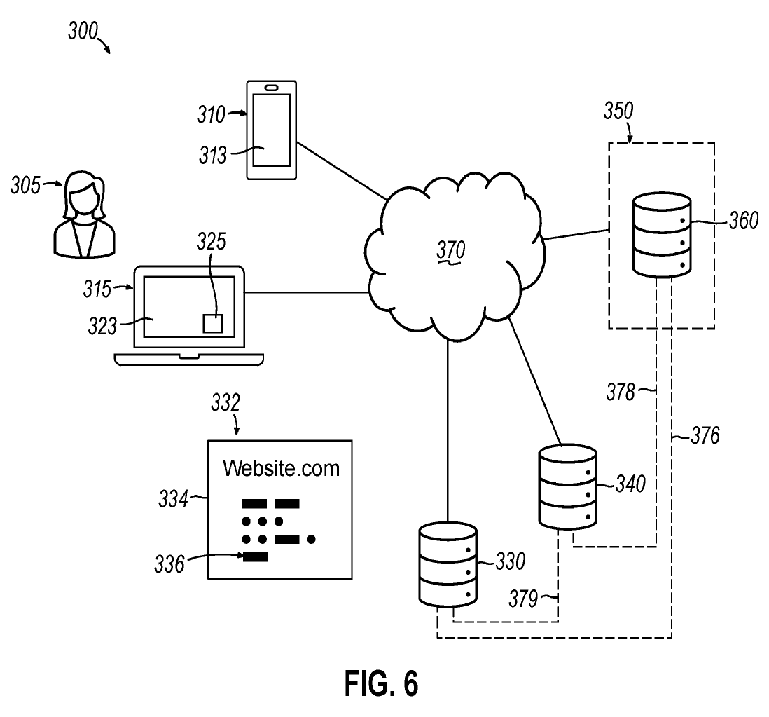

FIG. 6 displays a possible embodiment of a tag handling and identity syncing system 300 under the present disclosure. User 305 may utilize user devices 310, 315 (such as mobile device 310 and computer 315) with browser(s) 313, 323 to access a network 370. Network 370 may comprise one or more of: the internet, cellular networks, satellite networks, private/enterprise networks, other types of communication networks, and/or combinations of the foregoing. Website server(s) 330 may provide website(s) 332 for user 305 to browse. Website server 330 may comprise code 334 which is accessed by user devices 310, 315 and presents the website 332 to the user 305. Code 334 may comprise HTML (hypertext markup language), JavaScript, Java, Python, or other code that is configured to present website 332 to user 305, and/or provide functionality (e.g., shopping, maps, etc.) within website 332. Code 334 can include many parts, including tag(s) 336. Tracking server(s) 340 may comprise entities that track user 305 behavior, such as Google, Meta, and others. It should be noted that some entities will have both website servers 330 and tracking servers 340, and the same or related server(s) may provide both functionalities. For example, Google both has its own websites (e.g., google.com, for which it tracks data), and is a marketing partner to third parties (e.g., Google may use tracking servers 340 to track a user 305 across multiple websites). Tracking servers 340 may be associated with one or more tracking tools 325 which may be e.g., loaded onto a browser comprising user devices 310, 315. Tracking tools 325 may comprise tags, cookies, and/or other software that tracks user browsing activities. Generally, a cookie is a small piece of code placed on a user’s browser that helps to identify that user, such as when the user returns to an online store after several days without visiting. The cookie can identify that user and the user’s shopping cart can be just as the user left it several days prior. Generally, a tag (e.g., tag 336) is software code with website code 334 that assists in tracking a user’s visit to a site or group of sites (e.g., website.com), and reports it back to an entity, such as Google or Google Ads. Tag/identity sync system 350 may comprise tag/identity server(s) 360. Tag handling and identity tracking system 50 of FIG. 1 may comprise elements of one or more of: user devices 310, 315, network 370, website server(s) 330, tracking server(s) 340, and/or tag/identity sync system 350 of FIG. 6. Tag/identity server(s) 360, tracking server(s) 340, and website server(s) 330 can communicate via network 370 (e.g., the internet), but may also communicate via alternative direct or indirect networks or couplings, such as backend couplings 376, 378, 379. This is intended to show that communicative coupling between these elements can be achieved in various ways and means.

In a typical prior art scenario, a user 305 may visit e.g., website.com. Website code 334 for website.com may comprise several dozen tracking tags 336 for several dozen marketing partners of website.com, such as Google, Meta, etc. Each tag 336 may load cookie(s) 325 or other software onto browser(s) 313, 323. Cookie(s) 325 may track, collect, and transmit data about each page at website.com that user 305 visits. This can result in several dozen cookies 325 all operating simultaneously, consuming browser resources, and slowing down the user experience at website.com. Each cookie 325 spends resources running and e.g., sending data to each tracking server 340 associated with each respective cookie 325 (e.g., Google, Meta, Pinterest, etc.). Each cookie 325 may collect data in different formats, so while website.com may have access to the data collected, the data may be in various formats making it difficult for website.com to access, manipulate, monitor, analyze and otherwise monetize the data. It may also be possible that one or more cookies 325 are collecting private or other sensitive data that is illegal or otherwise subject to restrictions or protections. Website.com may wish to prevent this.

Tag handling and identity syncing system 300 can provide solutions to these shortcomings in the prior art. Embodiments under the present disclosure can replace the potentially dozens of tags 336 in the prior art with a single tag 336, all while providing browsing and website data to marketing partners and giving website owners increased control over their data, and giving users a better browsing experience. The following description uses FIG. 6 but instead of detailing the prior art, shows how embodiments of the present disclosure can function. Website code 334 provided by website server 330 (e.g., website.com) may comprise a single tag 336 that loads a cookie 325 (or set of cookies or other type of software code) on the user’s browser 313, 323. As user 305 visits the website cookie 325 will track data, e.g., pages visited, pages loaded, products viewed, etc. that detects what tracking tools 325 are currently on the user’s browser. Tag 336 and cookie 325 (loaded onto browser 313, 323 by website code 334 and tag 336) can be configured to detect user identify information on the browser 313, 323, such as by reading existing cookies or other information on browser 313, 323. For example, cookie 325 may detect that user 305 is e.g., known as (or otherwise uses the identifier) user 305 to Meta, topbrowser123yy@gmail.com to Google, and 451001xxxx to Pinterest. The tag 326 being run by website server 330 can ping each marketing partner (e.g., Facebook, Google, and Pinterest) such as by querying/retrieving information from tracking server(s) 340 for each partner for further identifying information regarding the user 305. An identity graph of the user can comprise a portion of cookie 325 loaded by website server 330 onto browser 313, 323. As user 305 visits website.com, each activity (e.g., page visit) is tracked, and can be sent to tag/identity server 360. Instead of each partner having its own cookie operating from its own domain, each operating simultaneously, in the embodiment described, just cookie(s) 325 can be running from website.com, and each event (e.g., product view) is sent once. Cookie(s) 325 can be said to comprise an owned set of multiple cookies from website.com’s partners. In this way, each partner still can be said to have their own cookie, but those cookies no longer need to be stored in each partner’s domain (e.g., meta.com). Instead, each cookie is “moved” to a first party domain e.g., website.com. Tag/identity server 360 detects the identity graph comprising cookie 325 and the respective identity information for e.g., Google, Meta, Pinterest. Tag/identity server 360 can then forward each event to each marketing partner (e.g., at tracking server(s) 340) separately with the data formatted for each marketing partner’s specific requirements. Tag/identity server 360 can also send the data/events to a database or other storage for use by the website owner. Such database(s) may comprise, e.g., a portion of website server(s) 330. Tag/identity server 360 preferably does not store the data long term. The identity information in cookie 325 may comprise e.g., email addresses, anonymous identification numbers, or other information or metadata. The data collection aspects and identity tracking aspects of tag 326 can generally be referred to as Sync Injector. Cookie 325 may remain on the user’s browser 313, 323 until the user 305 deletes it or it expires. If the user were to visit e.g., website.com at a later time, tag 326 would recognize cookie 325 and would not need to reload a new cookie and/or identity graph. Typically, first party cookies are allowed by browsers to have longer expiry windows than third party cookies. By “locating” third party cookies in owned first party sets of cookies, embodiments under the present disclosure can therefore maximize available expiry windows. Longer expiry windows can also be achieved by e.g., sync injector embodiments described herein that can control and refresh time stamps (e.g., instead of TradeDesk setting a 24 hour expiry).

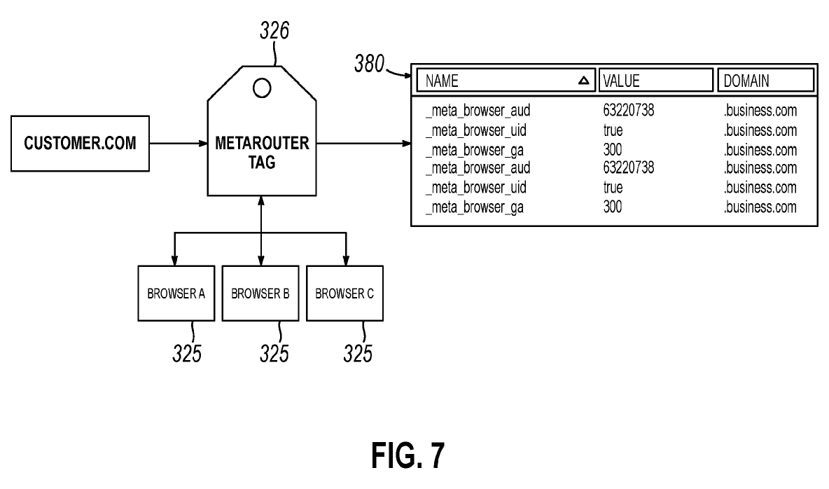

The identity information and/or other information contained in cookie 325 allows the website server 330 or tag/identity server 360 to identify the appropriate vendor (e.g., vendors A, B, C of FIG. 2, e.g., Google, Meta, or other marketing partners), which may be associated with e.g., a respective one of the tracking servers 340. Further description of cookie 325 and tag 326 can be seen in FIG. 7. A user may visit, e.g., website.com, and a tag 326 will load cookie 325 onto the browser. Tag 326 and by extension 325, can be preloaded with functionality/formatting for e.g., website.com’s marketing partners. But tag 326 will not load cookie 325 onto a browser until a given user visits the website. It can then read user ID information that is already on the browser, ping each marketing partner for additional identify information, and load an identity graph comprising cookie 325 onto the browser – and importantly, these cookies are placed in the 1^{st}-party context of the site, rather than the 3^{rd}. This means the website owner is able to access and control these cookies directly, rather than delegating this responsibility to the 3^{rd}-party vendors (e.g., Google, Meta, etc.). Each marketing partner may have a time frame within which they must respond with further identity information for the identity graph (e.g., 350 milliseconds). If one party fails to respond in time (e.g., Google), then when Google does respond then Google’s additional identity information can be added to the cookie 325 and identity graph within the browser. Because Google was late it may not receive the first event, such as the first page visit, or however many events occurred before the identity graph was updated.

Certain of the functionality described with respect to FIG. 6 can be illustrated with reference to FIG. 2. At 121, the sync injector system can cause identity collection modules to execute asynchronously. This can trigger vendor logic 126a/b/c for different vendors 127a/b/c. At 122 the monitoring library can run within the sync injector, and monitor metrics 128, such as success metrics, errors, API response, timing, samples, or other metrics. At 123, the metrics are compiled and sent to a metrics endpoint. At 124, the metrics endpoint receives the logs and metrics. At 125, the data can be loaded into a user interface for use by e.g., website managers and developers.

Referring now to aspects of FIG. 2, monitoring and data analysis of the sync injector and tag 326 activities and collection by cookie 325 can be described. The library runs within the sync injector and refers to the e.g., JavaScript libraries within tag 326 that run as a user visits, e.g., website.com. Certain functionalities of FIG. 2 can include monitoring the actions of the sync injector/tag 326 with respect to syncing for identity data with third parties, e.g., Google, Twitter, Xandr. Metrics monitored can include various data points, including: success metrics, errors, did call to vendor work, how fast do different vendors respond, API response success or speed, timing, samples, and other data. Data such as these can be monitored or measured, they can be compiled and sent to a metrics endpoint (e.g., an entity within tag/identity server 360 or another recipient), the metrics endpoint can receive the logs and metrics, and the data can be loaded into a user interface for e.g., website.com owners to review and analyze further. Aspects of FIG. 2 can be performed at one or more of the components of system 300 of FIG. 6, e.g.: tag 326, tag/identity system 350 or tag/identity server(s) 360, website server(s) 330, or tracking server(s) 340, or combinations of the foregoing. Functionalities may be controlled or manipulated by e.g., tag/identity server 360 but may be distributed across various elements of system 300.

Another aspect of FIG. 6 is that the sync injector/tag 326 (and/or tag/identity server 360 or tag/identity system 350) can contact e.g., Google, Twitter, etc. via vendor logic A/B/C and retrieve identity information related to the user. Tracking tools 325 may contain a user ID that is largely useless to the website owner when the user visits the website. But the user ID (or other data prearranged and agreed to by the given marketing partner) can be sent to the appropriate vendor who will then respond with more complete user information which can include, a true identity, a browser history, activity history, or other data. This data can allow the website owner to create more accurate data about its audience. For example, this data may include age, gender, home state, home country, a source link that directed the user to the website, or other data. This can allow the website owner to better understand features like: success of certain marketing campaigns, success of links on certain websites, popularity within countries, demographics of target customers, or other features. This allows the website owner to have more accurate data about those users who visit its website and allows for more efficient monetization through targeted marketing efforts.

In the embodiment shown in FIG. 6, identity server(s) 360 are shown as remote to website servers 330. However, in some embodiments the functionality of identity server 360 may be implemented in an “on premises” embodiment. For example, website.com may use website servers 330 to provide its website to users. In some embodiments, tag/identity server 360 may be provided, hosted and managed by a third party to website.com. However, in other embodiments, the third party may load the functionality of tag/identity server 360 onto servers (e.g., website servers 330) provided, hosted, or managed by website.com. Similarly, tracking server 340 could comprise at least a portion of the functionality described with respect to tag/identity server 360.

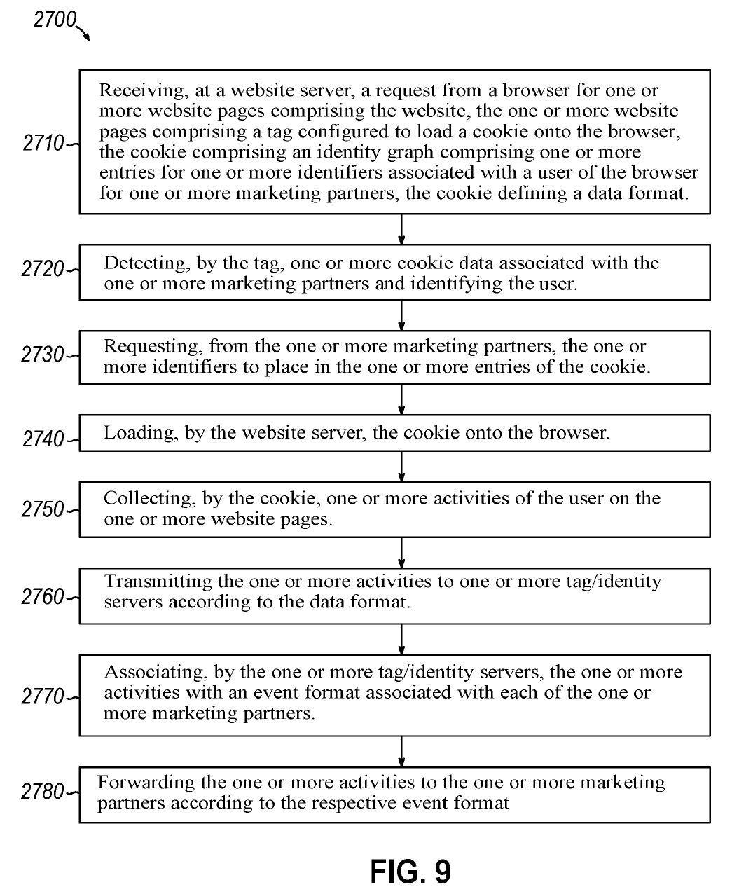

FIG. 9 displays one possible embodiment of a method 2700 under the present disclosure. Method 2700 comprises a computer implemented method of managing one or more tracking tools in a browser. Step 2710 is receiving, at a website server, a request from a browser for one or more website pages comprising the website, the one or more website pages comprising a tag configured to load a cookie onto the browser, the cookie comprising an identity graph comprising one or more entries for one or more identifiers associated with a user of the browser for one or more marketing partners, the cookie defining a data format. Step 2720 is detecting, by the tag, one or more cookie data associated with the one or more marketing partners and identifying the user. Step 2730 is requesting, from the one or more marketing partners, the one or more identifiers to place in the one or more entries of the cookie. Step 2740 is loading, by the website server, the cookie onto the browser. Step 2750 is collecting, by the cookie, one or more activities of the user on the one or more website pages. Step 2760 is transmitting the one or more activities to one or more tag/identity servers according to the data format. Step 2770 is associating, by the one or more tag/identity servers, the one or more activities with an event format associated with each of the one or more marketing partners. Step 2780 is forwarding the one or more activities to the one or more marketing partners according to the respective event format. Method 2700 can comprise a variety of alternative or additional steps. For example, in some variations, method 2700 can further comprise monitoring the transmitting and the requesting for one or more metrics.

### Alternative System Embodiments

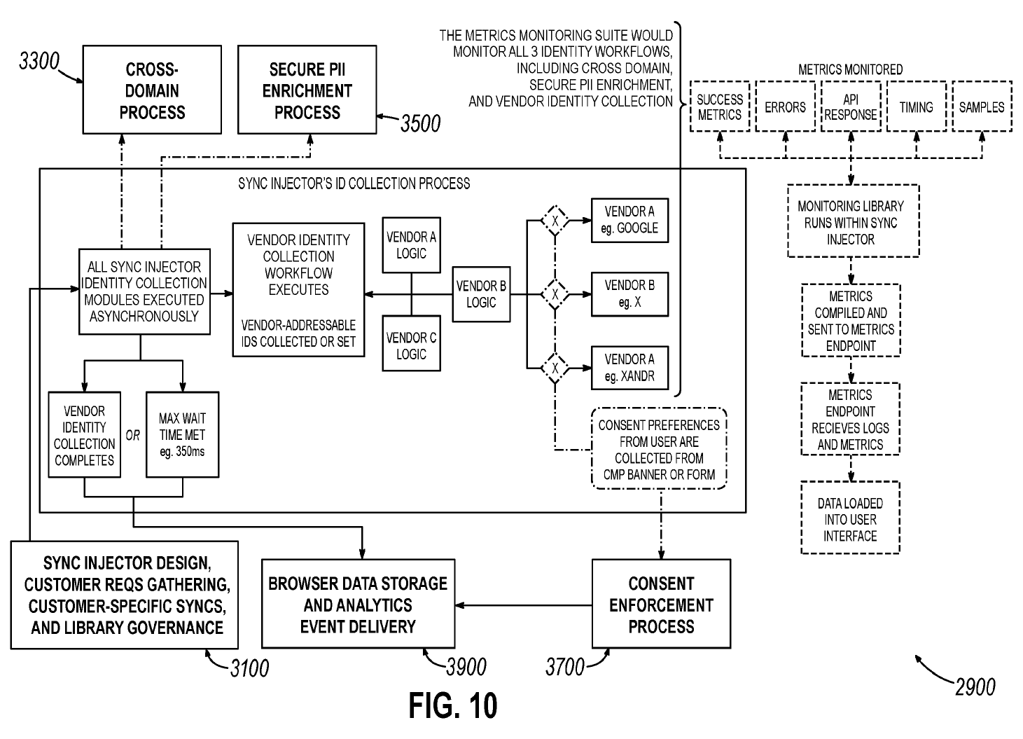

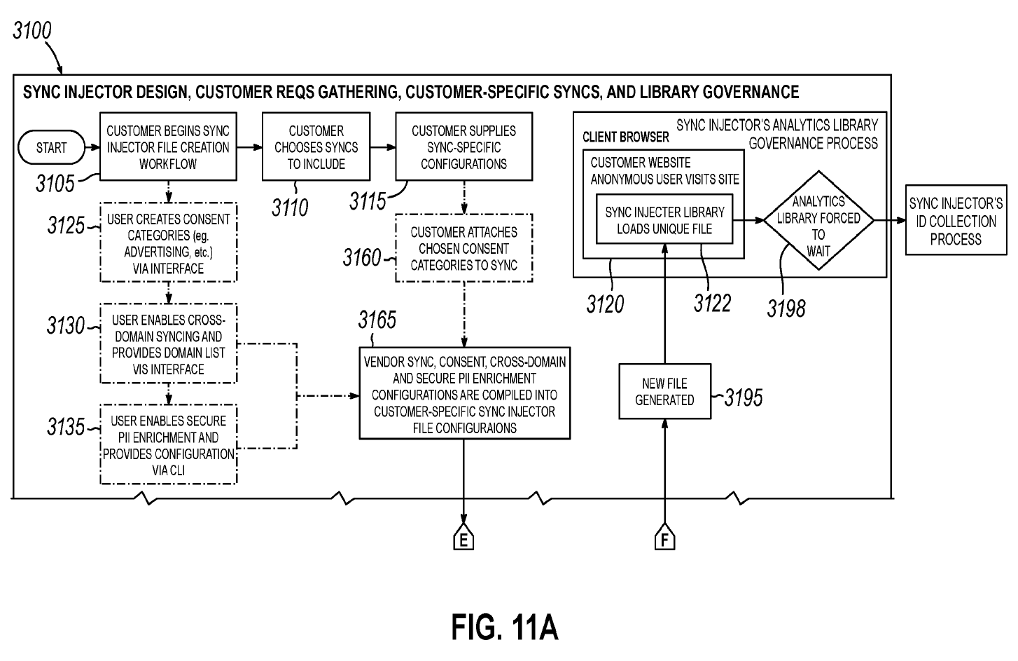

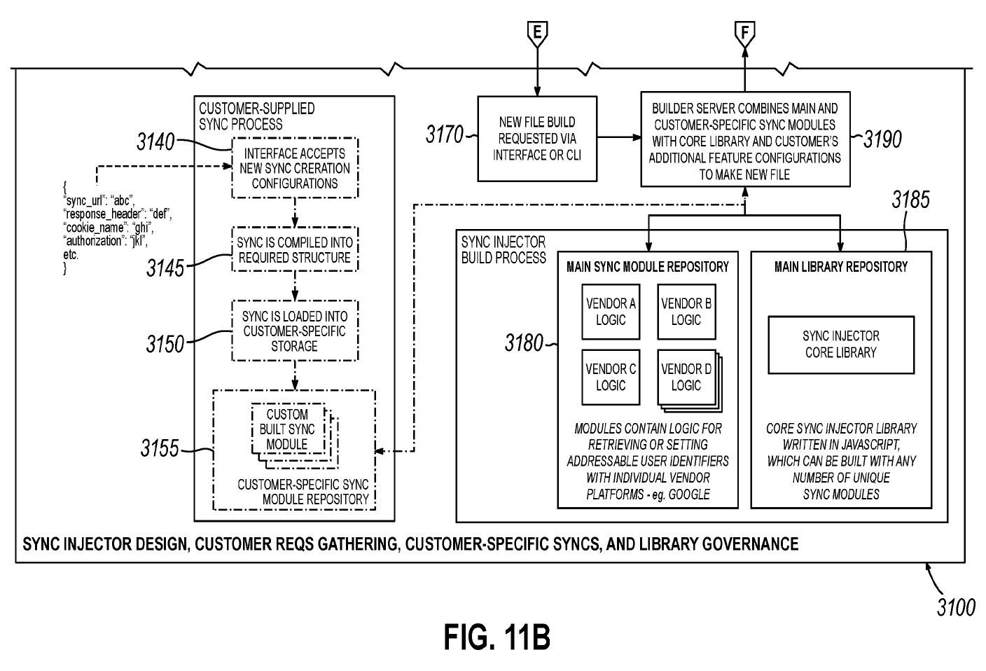

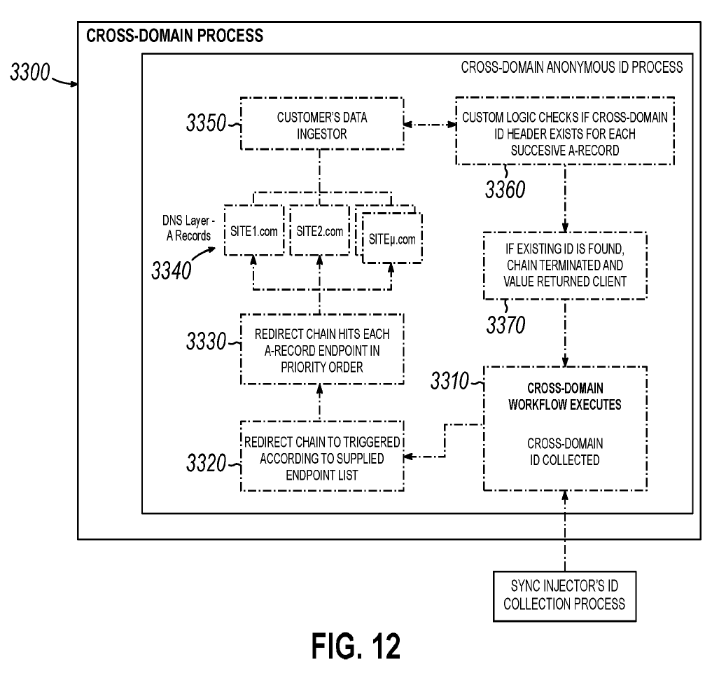

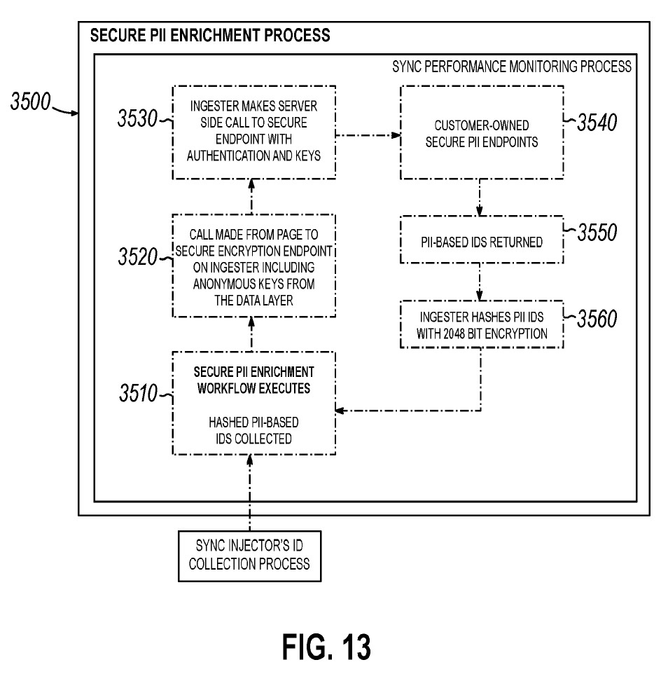

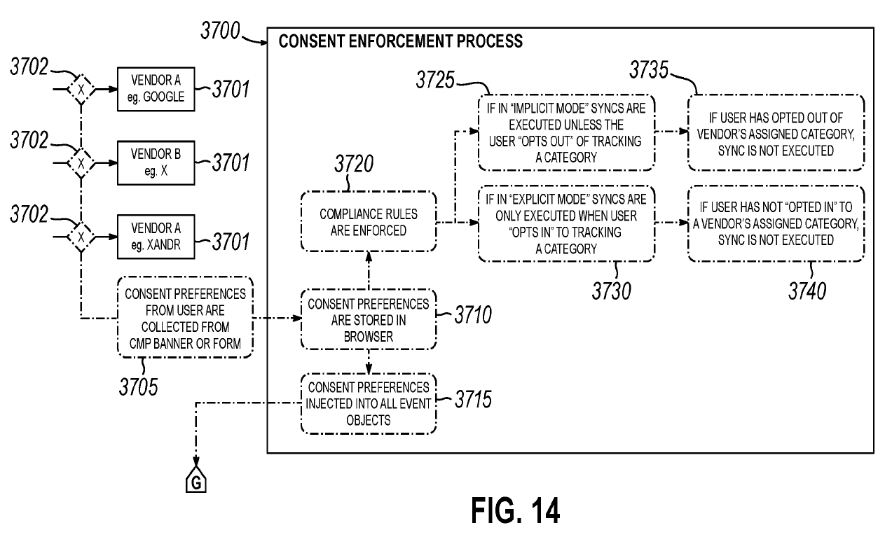

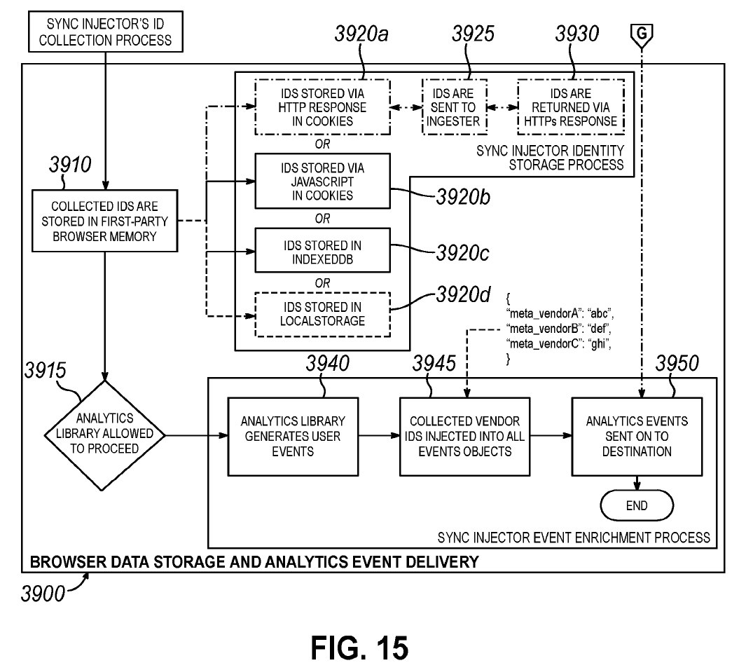

FIG. 10 illustrates another embodiment of a browser tag handling and identity tracking system 2900 under the present disclosure, similar in some ways to FIG. 1, but with some additional details, functionalities and variations. Functionalities include the handling or consolidation of browser tag and user tracking capabilities as well as identity tracking and syncing across browsers, websites and tracking systems. Embodiments under the present disclosure include a variety of sub-systems and sub-methods within system 2900 and its associated method embodiments. Embodiments under the present disclosure include various portions within system 2900, including:
Sync injector build process systems and methods, seen in 3100 and FIGS. 11A-11B;
Sync injector analytics library governance systems and methods, seen in 3100 and FIGS. 11A-11B;
Sync injector ID collection systems and methods, seen in FIG. 10 (some embodiments of which were described with respect to FIGS. 1-9);
Sync injector ID storage systems and methods, including a) HTTP response process, b) 1P cookie process, c) indexed DB (database) process, d) local storage process; seen in 3900 and FIG. 15;
Sync injector event enrichment systems and methods, seen in 3900 and FIG. 15;
Sync injector consent enforcement process, seen in 3700 and FIG. 14;
Sync injector customer supplied sync process, seen in 3100 and FIGS. 11A-11B;
Sync injector cross-domain anonymous ID systems and methods, seen in 3300 and FIG. 12;
Sync injector secure PII (personally identifiable information) enrichment systems and methods; seen in 3500 and FIG. 13; and
Sync performance monitoring systems and methods, seen in FIG. 10.

The various portions of FIG. 10, and the respective embodiments can further be grouped roughly into the following groups (noting that there is some overlap and interaction between the illustrated elements):
Sync Injector Design, Customer Requirements Gathering, Customer-Supplied Syncs, and Library Governance (one embodiment shown in sync injector design process 3100 of FIG. 11A-11B);
Cross-Domain Process (one embodiment shown in cross domain process 3300 of FIG. 12);
Secure PII Enrichment Process (one embodiment shown in secure PII enrichment process 3500 of FIG. 13);
Consent Enforcement Process (one embodiment shown in consent enforcement process 3700 of FIG. 14);
Browser Data Storage and Analytics Event Delivery (one embodiment shown in browser data storage process 3900 of FIG. 15).

Some of the following descriptions focus on aspects related to various functionalities related to sync injector design process 3100 of FIG. 11A-11B.

### Sync Injector Embodiments

Sync injector design process 3100 can be performed by e.g., tag/identity sync system 350 and/or tag/identity server(s) 360 of FIG. 6, or by other computing device embodiments described herein. Regarding terminology, a distinction should be made between a ‘sync injector’ and a ‘sync module’ as used herein. For purposes of the present disclosure, a sync injector refers to the full code library/framework provided by system 50 or 300 (e.g., tracking servers 340 of FIG. 6) for the purpose of the site owner deploying this library on their website in order to execute many different forms of synchronization with its various commercial marketing partners, such as Google Ads, Facebook, etc. For example, sync system 350 may provide a sync injector to ABC Company for use on abccompany.com. That sync injector can manage synchronization with e.g., Google Ads, TikTok, etc. A ‘sync module’ refers to partner-specific code deployed by the sync injector. For example, a sync injector for abccompany.com can deploy, e.g., a Google Ads sync module for interfacing/synchronizing data with Google Ads, a TikTok sync module for interfacing/synchronizing data with Tiktok, etc. As further described below, various sync injectors or sync modules may be created/deployed by/shared by tag/identity sync system 350 of FIG. 6 for use by e.g., website server 330 to provide website(s) 332 for user 305 to browse. A given sync injector (e.g., for abccompany.com) may comprise any number of individual sync modules for each of the commercial partners that ABC Company wishes to integrate. A sync injector may comprise or be populated with additional modules for other tasks, e.g., PII-related functionality, cross domain syncing, or other modules.

Sync injector file creation workflow 3100 can start at 3105, wherein a customer/user of tag/identity sync system 350 begins process 3100. This can be by e.g., tag/identity sync system 350 providing a user interface for a user to engage with the workflow 3100. At 3110, the customer chooses sync modules to include in a website they are developing or deploying. There may be a separate sync module for each commercial marketing partner, each associated with e.g., a tracking server 340 of FIG. 6. Examples can include Google Ads, Tiktok, Facebook, or other marketing or data tracking services. At 3115, the user can supply or enter various sync module-specific configurations (e.g., authorization keys, expiry, etc.). At 3125, the user can create consent categories (e.g., advertising, necessary, etc.) for each of the sync modules chosen at 3110. At 3160, the customer can attach the chosen consent categories to the chosen sync modules. At 3130, the user can enable cross domain syncing by providing a domain list (this may enable/create a separate cross domain syncing module). At 3135, the user can enable secure PII enrichment by providing configuration information via CLI (this may enable/create a separate PII module). At 3165, the vendor sync injector, consent, cross-domain, and/or secure PII enrichment configurations are compiled together into a customer-specific sync injector file configuration. In the example of a ABC Company sync injector, at 3165, the sync injector file configuration can be made up of e.g., a Facebook sync module with customer specific consent and configuration preferences, a TikTok sync module with customer specific consent and configuration preferences, a cross domain module with customer-specific domain list, and secure PII module to fit the customers preferences, and/or other sync modules for ABC Company’s partners (e.g. Google, X, etc.). At 3170, a new file build is requested via a user interface or CLI.

Main sync module repository 3180 can store the vendor logic or sync modules for various commercial partners (e.g., Facebook, Google, X, etc.) which can be added to each sync injector as needed. The logic or modules can contain logic for retrieving or setting addressable user identifiers with individual vendor platforms - e.g., Google, Twitter, etc. These modules can be stored as fully built out (or almost fully built out) code, which are just missing a few configurations from a given customer (e.g., ABC Company, etc.). These modules are stored and can be combined with, or populated with information collected or developed in e.g., step 3115.

At 3185, main library repository comprises a sync injector core library 3185. Sync injector core library 3185 can store the basic core code for a sync injector. This core code can be used at e.g., step 3190 as the basic sync injector code to which specific desired sync modules should be added.

For scenarios in which a client has a need for a new sync module, wherein a pre-existing module or template from the main sync module repository 3180 is unavailable, FIG. 11B shows a process for creating a custom sync module. This could occur, for example, if ABC Company wants a sync module for Pinterest, but there is no pre-existing Pinterest logic stored in main sync module repository 3180. At step 3140, a user interface can accept a new sync module creation configuration (an example possible configuration is shown). From there, at 3145, the sync module is compiled into a required structure. At 3150, sync module is loaded into customer-specific storage. At 3155, a custom-built sync module is stored in the customer-specific sync module repository.

Returning to step 3190, the builder server retrieves core sync injector code from sync injector core library 3185 to build a new sync injector for e.g., ABC Company. The builder server can then take the information received from steps 3105 to 3170 (for specific vendors, cross domain modules, and/or PII modules) and populate the appropriate vendor logic retrieved from main sync module repository 3180, and retrieve any custom built sync modules from custom built sync module repository 3155. The builder server can then populate the core sync injector code with e.g., sync modules for the customer’s desired vendors (Facebook, X, etc.) populated with information collected, any custom-built sync modules 3155, cross domain module(s) if desired, and/or PII module(s) if desired, and build the sync injector to be used at abccompany.com.

Referring again to step 3190, during deployment at a client website, a new file of each respective sync injector is created at 3195 and uploaded, or transmitted to, the client’s website 3120. When a website user visits a customer's website running the sync injector, each respective sync module (e.g., Facebook, X, etc.) with all the customer's configurations is available in the sync injector library, which loads each unique sync module at 3122 (also described in regard to FIG. 2, FIGS. 11A-11B, and in other embodiments). When the sync injectors begin running, the analytics library may be temporarily forced to wait, at 3198, as described further with respect to other embodiments hereunder. From step 3198 of FIG. 11A, the process may move to e.g., step 121 of FIG. 2, wherein the identity collection modules begin executing asynchronously, and e.g., vendor-addressable IDs are collected or set.

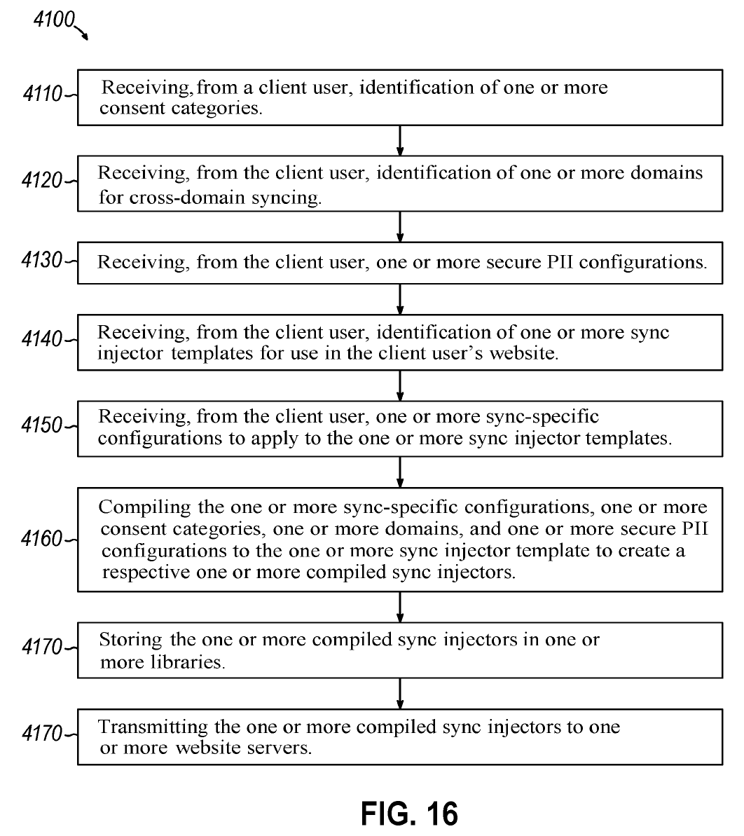

A possible method embodiment is shown in FIG. 16. Method 4100 is a computer implemented method of creating one or more tracking tools for use in an internet browser. Step 4110 is receiving, from a client user, identification of one or more consent categories. Step 4120 is receiving, from the client user, identification of one or more domains for cross-domain syncing. Step 4130 is receiving, from the client user, one or more secure PII configurations. Step 4140 is receiving, from the client user, identification of one or more sync injector templates for use in the client user’s website. Step 4150 is receiving, from the client user, one or more sync-specific configurations to apply to the one or more sync injector templates. Step 4160 is compiling the one or more sync-specific configurations, one or more consent categories, one or more domains, and one or more secure PII configurations to the one or more sync injector template to create a respective one or more compiled sync injectors. Step 4170 is storing the one or more compiled sync injectors in one or more libraries. Step 4180 is transmitting the one or more compiled sync injectors to one or more website servers. Method 4100 can comprise a variety of additional, alternative, and/or optional steps and/or other variations.

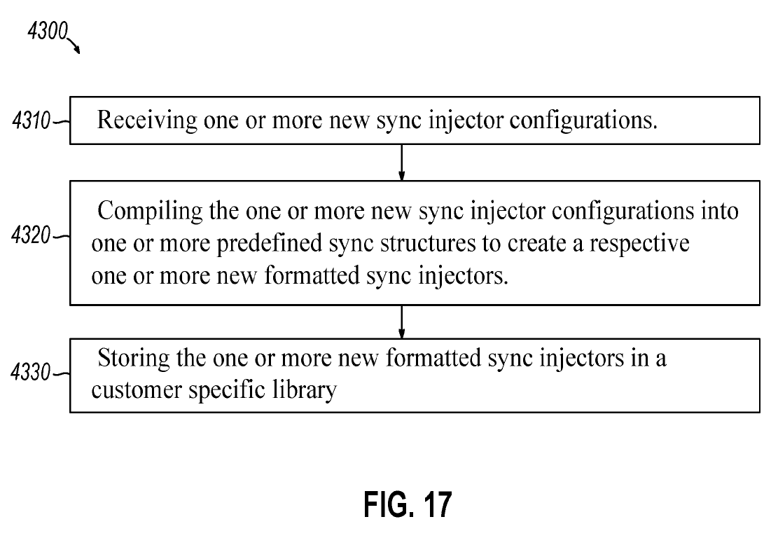

Another possible method embodiment is shown in FIG. 17. Method 4300 is a computer implemented method of creating one or more tracking tools for use in an internet browser. Step 4310 is receiving one or more new sync injector configurations. Step 4320 is compiling the one or more new sync injector configurations into one or more predefined sync structures to create a respective one or more new formatted sync injectors. Step 4330 is storing the one or more new formatted sync injectors in a customer specific library. Method 4300 can comprise a variety of additional, alternative, and/or optional steps and/or other variations.

### Consent Enforcement Process Embodiments

Some of the following description focuses on possible embodiments under the present disclosure of a consent enforcement process, one embodiment shown in consent enforcement process 3700 of FIG. 14. Aspects of FIGS. 10 and 14 can be performed at one or more of the components of system 300 of FIG. 6, e.g., tag 326, tag/identity system 350 or tag/identity server(s) 360, website server(s) 330, or tracking server(s) 340, or combinations of the foregoing. Functionalities may be controlled or manipulated by e.g., tag/identity server 360 but may be distributed across various elements of system 300. Process 3700 can occur in tandem or simultaneously with certain functionalities described with respect to FIG. 2.

When users visit webpages, they are commonly presented with banners or popups asking for consent or preferences related to cookies, tags, and/or other tracking activity. These banners are commonly from a CMP (Consent Management Platform). Embodiments of a CMP banner or consent form are presented to a user, who can then select what types of cookies or other tracking techniques or technologies to allow. Examples of CMP providers include OneTrust™ and TrustArc™. In the prior art, it is difficult for a website manager/owner to ensure that its third-party marketing partners are abiding by user consent preferences. For example, website.com might have marketing partners Google, Facebook, etc. Website.com might also use OneTrust as a CMP to collect user preferences. As described above with regard to identity synchronization, synthesizing, integrating and/or consolidating data across a CMP, multiples marketing partners, and ensuring compliance with user consent preferences is difficult and onerous.

As was described in relation to FIGS. 2 and 6, identity information and/or other information contained in cookie 325 allows the website server 330 or tag/identity server 360 to identify the appropriate vendor (e.g., vendors A, B, C of FIGS. 2 or 10, e.g., Google, Meta, or other marketing partners), which may be associated with e.g., a respective one of the tracking servers 340. In certain embodiments, a user may visit, e.g., website.com, and a tag 326 will load cookie 325 onto the browser. Tag 326 and by extension 325, can be preloaded with functionality/formatting for e.g., website.com’s marketing partners, such as vendors 3701 of FIG. 14 (or e.g. vendors A, B, C of FIGS. 2 or 10). Sync injector/tag 326 (and/or tag/identity server 360 or tag/identity system 350) can contact vendors 3701 of FIG. 14 and retrieve identity information related to the user. Tracking tools 325 may contain a user ID that is largely useless to the website owner when the user visits the website. But the user ID (or other data prearranged and agreed to by the given marketing partner) can be sent to the appropriate vendor who will then respond with more complete user information which can include, a true identity, a browser history, activity history, or other data. This data can allow the website owner to create more accurate data about its audience. As part of this process, vendor logic 3702 for e.g., Google, Twitter, etc. can also collect user preferences regarding consent. At step 3705, consent preferences from users are collected from e.g., a CMP banner or a form. Once consent preferences are collected, they can be stored in the browser at step 3710. After step 3710, step 3720 can include enforcing compliance rules. The consent preferences can fall into implicit mode or explicit mode. If implicit mode is set or chosen by a user, then at 3725 the syncs are executed unless the user “opts out” of tracking a category. And at 3735 if the user has opted out of vendors assigned category(ies) then sync is not executed. If explicit mode is set or chosen by a user, then at 3730 syncs are only executed when user “opts in” to tracking a category(ies). And then at 3740, if a user has not opted in to a vendor’s assigned category(ies) then sync is not executed. In implicit mode, consent is implied, until a user indicates otherwise. In explicit mode, in contrast, nonconsent/refusal is implied until a user indicates otherwise. Implicit mode is common in the United States. Explicit mode is common in Europe, such as under GDPR (General Data Protection Regulation). In certain embodiments using implicit mode, the system may track the user’s data. But if a user later changes their settings, or otherwise chooses to reject cookies/tracking, then the system can delete the data collected about that user, even the data already collected.

From step 3710, the process can also proceed to step 3715. At step 3715, the consent preferences of a user can be injected into all event objects. Event objects can include tracked events associated with that user: pages visited, actions taken on which pages, links clicked, money spent, or other events. By injecting the consent preferences into the event objects, this allows the consent preferences to “travel” with the event object data. In this way, when event object data is analyzed in further processes, the consent preferences are readily available and “attached” to the event object data. In this way a component or process analyzing the event object data does not have to reach out to another system or process to obtain consent preference data that may limit how the event object data of a given user may be used. In the prior art, a CMP may collect user consent preferences, and those consents may be associated with a username, email address or other identifier. But coordinating the enforcement of those consents with each marketing partner of a website was difficult in the prior art. The consent settings did not “travel” with the event objects in the prior art, so there needed to be additional transactions between CMPs and marketing partners in order to associate consent preferences with user identifiers used by the marketing partners. This prior art process was onerous and used up valuable resources.

The user consent preferences or categories applied by a CMP or other popup can have been created by a website developer at e.g., FIG. 11A-11B, at step 3125. These consent categories can then be built into a sync injector for a website, such as by sync injector file creation workflow 3100 described in relation to FIG. 11A-11B.

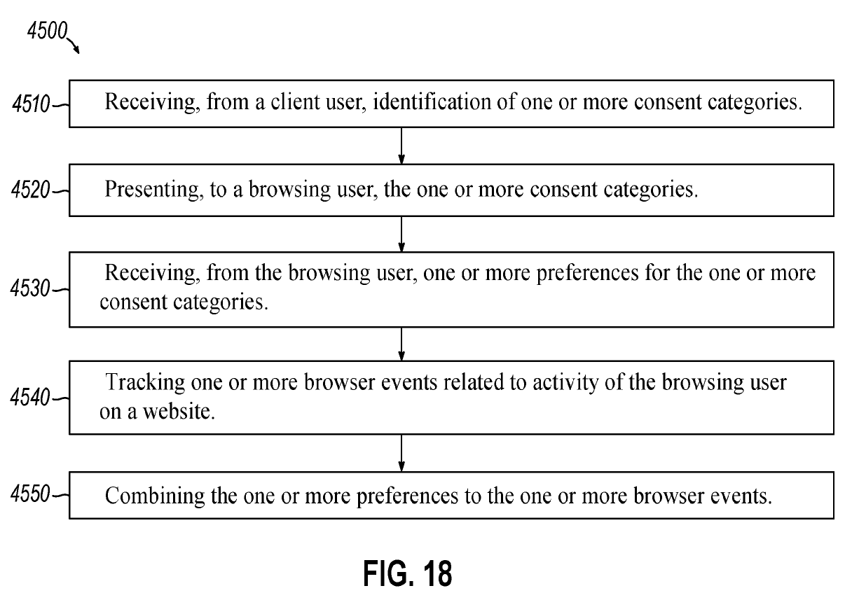

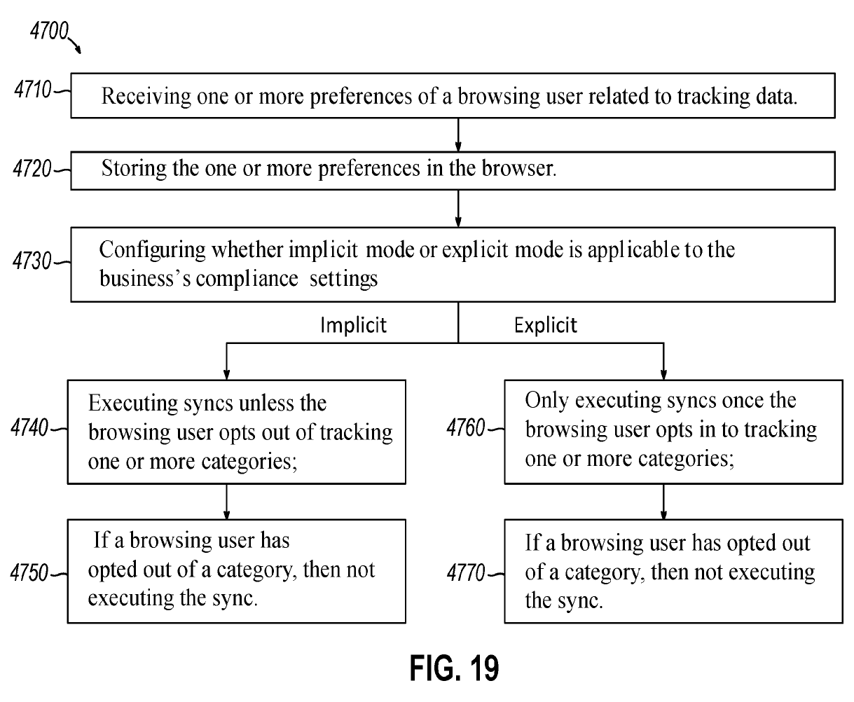

FIGS. 18 and 19 illustrate possible method embodiments under the present disclosure.

FIG. 18 illustrates a computer implemented method 4500 for enforcing user consent preferences related to one or more tracking tools for use in an internet browser. Step 4510 is receiving, from a client user, identification of one or more consent categories. Step 4520 is presenting, to a browsing user, the one or more consent categories. Step 4530 is receiving, from the browsing user, one or more preferences for the one or more consent categories. Step 4540 is tracking one or more browser events related to activity of the browsing user on a website. Step 4550 is combining the one or more preferences to the one or more browser events. Method 4500 can comprise alternative, additional, and/or optional steps or other variations. For example, further steps can include transmitting the combined preferences and browser events to a marketing partner.

FIG. 19 illustrates a computer implemented method 4700 for enforcing user consent preferences related to one or more tracking tools for use in an internet browser. Step 4710 is receiving one or more preferences of a browsing user related to tracking data. Step 4720 is storing the one or more preferences in the browser. Step 4730 is configuring whether implicit mode or explicit mode is applicable to the business’s compliance settings. If implicit mode is applicable, then the method can perform the steps of; 4740, executing syncs unless the browsing user opts out of tracking one or more categories; and 4750, if a browsing user has opted out of a category, then not executing the sync. If explicit mode is applicable, then the method can perform the steps of 4760, only executing syncs once the browsing user opts in to tracking one or more categories; and at 4770, if a browsing user has opted out of a category, then not executing the sync. Method 4700 can comprise alternative, additional, and/or optional steps or other variations.

### Cross Domain Process Embodiments

FIG. 12 illustrates a possible cross-domain process 3300 under the present disclosure. Embodiments with certain similar functionality are shown in FIGS. 3, 1, and 10. Cross-domain process 3300 can be performed by e.g., browser(s) 310, 315, website server(s) 330, tracking server(s) 340, and/or tag/identity sync system 350, and/or tag/identity server(s) 360, of FIG. 6, or by other computing device embodiments of tag handling and identity syncing system 300 described herein. As described above, after the creation and deployment of a sync injector at a web server, (see e.g., FIG. 11A-11B) with one or more sync modules for each of one or more vendors (e.g., Facebook, X, etc.), the sync injector can load each sync module onto a customer’s browser. Next, in certain embodiments the process may move to e.g., step 121 of FIG. 2, wherein the sync modules begin executing asynchronously, and e.g., vendor-addressable IDs are collected or set. The vendor-addressable IDs can also be referred to as cross-domain IDs. Along with the identity syncing process 120 of FIG. 2, cross-domain process 3300 can occur.

At 3310, a cross-domain ID is collected. This may identify a user/website visitor, such as a username, email address, number ID, or other identifier that identifies a user with respect to e.g., a Google account, Facebook account, X account, etc. In certain embodiments the ID may be anonymized or edited or redacted to remove personally identifying information. At 3320, a redirect chain is triggered according to a supplied endpoint list. This list may provide instructions/APIs/server addresses for confirming or authenticating the collected cross-domain IDs. At 3330, the redirect chain hits each A-record (address record) endpoint in priority order. Orders of priority can be set in a variety of ways. At 3340, the process can check each cross-domain ID with each related vendor site (e.g., site1.com, site2.com, etc.) via communicating with each vendor’s website/domain (e.g., their DNS layer A-record). At 3350, the customer (e.g. website manager or owner) system may ingest information received from the vendor sites. At 3360, the customer logic can check if a cross-domain ID header exists for each successive A-record. At 3370, if an existing ID is found, then the cross-domain ID and/or related information can be returned to the client/browser. This ID or related information can be collected and stored with user data that is further processed with regard to other processes as described herein, such as identity syncing process 120 of FIG. 2.

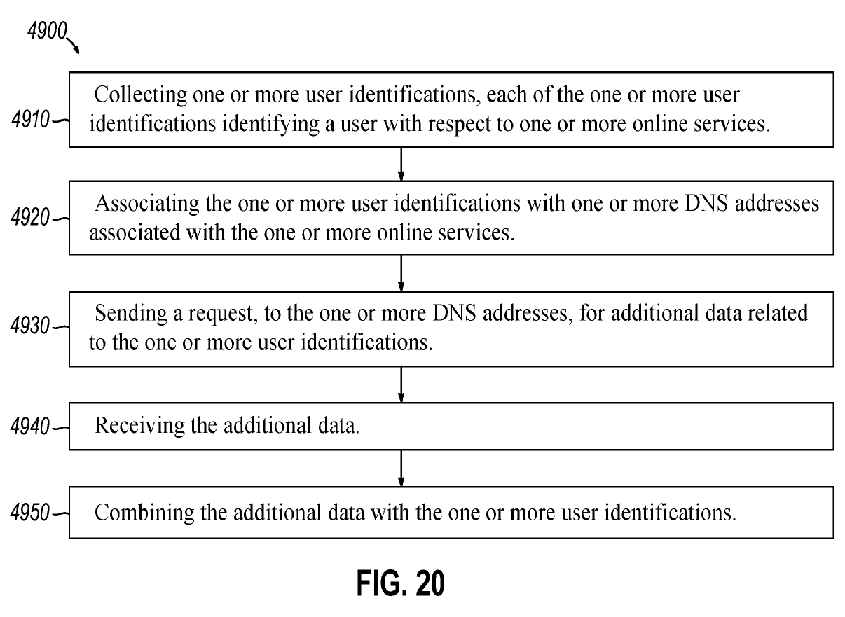

FIG. 20 illustrates a possible method embodiment under the present disclosure. Method 4900 comprises a computer implemented method for tracking cross-domain user identifications. Step 4910 is collecting one or more user identifications, each of the one or more user identifications identifying a user with respect to one or more online services. Step 4920 is associating the one or more user identifications with one or more DNS addresses associated with the one or more online services. Step 4930 is sending a request, to the one or more DNS addresses, for additional data related to the one or more user identifications. Step 4940 is receiving the additional data. Step 4950 is combining the additional data with the one or more user identifications. Method 4900 can comprise various additional, alternative or optional steps or other variations.

### Secure PII Enrichment Process

FIG. 13 illustrates a possible secure PII (personally identifying information) enrichment process 3500 under the present disclosure. Embodiments with certain similar functionality are shown in FIG. 10. Secure PII enrichment process 3500 can be performed by e.g., browser(s) 310, 315, website server(s) 330, tracking server(s) 340, and/or tag/identity sync system 350, and/or tag/identity server(s) 360, of FIG. 6, or by other computing device embodiments of tag handling and identity syncing system 300 described herein. As described above, after the creation and deployment of a sync injector at a web server, (see e.g., FIG. 11A-11B) with one or more sync modules for each of one or more vendors (e.g., Facebook, X, etc.), the sync injector can load each sync module onto a customer’s browser. Next, in certain embodiments the process may move to e.g., step 121 of FIG. 2, wherein the sync modules begin executing asynchronously, and e.g., vendor-addressable IDs are collected or set. The vendor-addressable IDs can also be referred to as cross-domain IDs. Along with the identity syncing process 120 of FIG. 2, and cross-domain syncing process 3300 of FIG. 12, secure PII enrichment process 3500 can occur.

Secure PII enrichment process 3500 can provide another ID (in the form of PII) that can be used to expand the business’ understanding of the user and provide another ID to expand match when integrating data into other systems. At 3510, hashed PII-based IDs are collected. A hash is an algorithm that takes an input of any size and transforms it into a unique, fixed-length output. Hashing a value is a common way to encrypt it. At 3520, the system can include a call from the webpage to a secure encryption endpoint on an ingestor system including anonymous keys from the data layer. The ingestor system can comprise e.g., tag/identity sync system 350 and/or tag/identity server(s) 360 of FIG. 6, or by other computing device embodiments described herein. At 3530, the ingestor can make a server-side call to a secure endpoint with authentication and keys. At 3540, the secure PII endpoint can receive the call. The secure PII endpoint may comprise a customer-owned server/database/computing device. At 3550, PII-based IDs are returned to the ingestor. At 3560, the ingestor hashes PII IDs. This may be done e.g., via 2048-bit encryption. The PII may then be combined with other data about users/website visitors that is further processed with regard to other processes as described herein, such as identity syncing process 120 of FIG. 2.

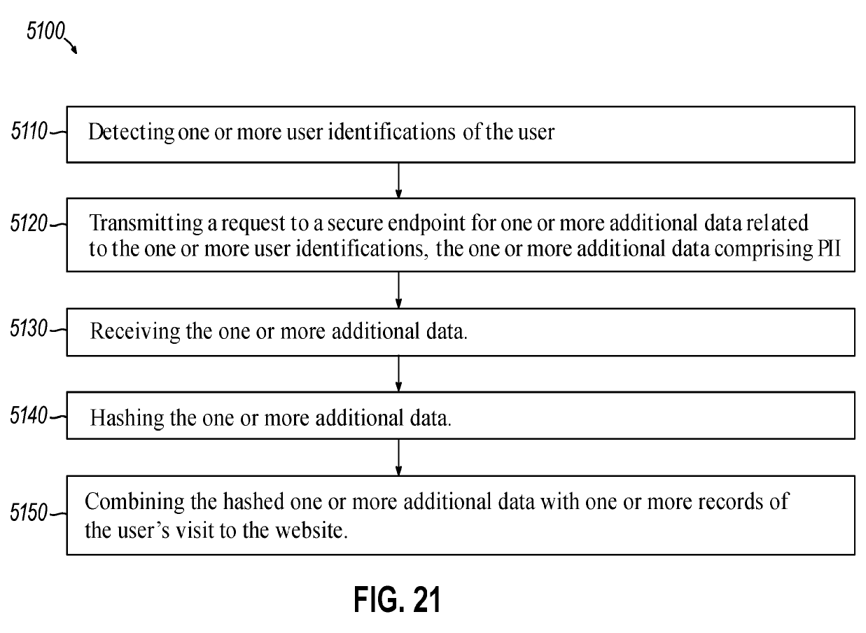

FIG. 21 illustrates a possible method embodiment under the present disclosure. Method 5100 comprises a computer implemented method for enriching one or more hashed user identifications of a user visiting a website. Step 5110 is detecting one or more user identifications of the user. Step 5120 is transmitting a request to a secure endpoint for one or more additional data related to the one or more user identifications, the one or more additional data comprising PII. Step 5130 is receiving the one or more additional data. Step 5140 is hashing the one or more additional data. Step 5150 is combining the hashed one or more additional data with one or more records of the user’s visit to the website. Method 5100 can comprise various additional, alternative or optional steps or other variations.

### Browser Data Storage and Analytics Event Delivery Process

FIG. 15 illustrates a possible browser data storage and analytics event delivery process 3900 under the present disclosure (referred to below as browser data storage process 3900). Embodiments with certain similar functionality are shown in FIG. 10. Browser data storage process 3900 can be performed by e.g., browser(s) 310, 315, website server(s) 330, tracking server(s) 340, and/or tag/identity sync system 350, and/or tag/identity server(s) 360, of FIG. 6, or by other computing device embodiments of tag handling and identity syncing system 300 described herein. As described above, after the creation and deployment of a sync injector at a web server, (see e.g., FIG. 11A-11B) with one or more sync modules for each of one or more vendors (e.g., Facebook, X, etc.), the sync injector can load each sync module onto a customer’s browser. Next, in certain embodiments the process may move to e.g., step 121 of FIG. 2, wherein the sync modules begin executing asynchronously, and e.g., vendor-addressable IDs are collected or set. Along with the identity syncing process 120 of FIG. 2, cross-domain syncing process 3300 of FIG. 12, and secure PII enrichment process 3500 of FIG. 13, browser data storage process 3900 can occur.

Browser data storage process 3900 can occur e.g., as a user/website visitor is visiting e.g., website 332 and visiting different pages within website 332 and otherwise interacting with the website 332 such as by clicking on links, making purchases, etc. At 3910, collected IDs are stored within a first-party browser memory. The storage, at 3920a/b/c/d, can be via various means depending on different browser or website server deployments. Possible means include, e.g.: IDs stored via HTTP response in cookies 3920a; IDs stored via Javascript in cookies 3920b; IDs stored in IndexedDB (an indexed database) 3920c; and IDs stored in local storage 3920d. If IDs are stored via HTTP response in cookies 3920a, then at 3925 the IDs are sent to the ingestor, and at 3930 the IDs are returned via HTTP response. At 3915, the analytics library is allowed to proceed. At 3940, the analytics library generates user events (e.g., in response to user actions such as clicking a link, making a purchase, or other actions). At 3945, collected vendor IDs are injected into all event objects. This can allow the vendor IDs to “follow” the data. As the data is stored the related vendor IDs are stored along with the event. As the data is further processed for various purposes, vendors that are allowed to receive such data or processed data can be quickly identified. At 3950, analytics events can be sent to a destination. Destinations can include, e.g., website server(s) 330, tracking server(s) 340, and/or tag/identity sync system 350, and/or tag/identity server(s) 360 of FIG. 6, or by other computing device embodiments of tag handling and identity syncing system 300 described herein.

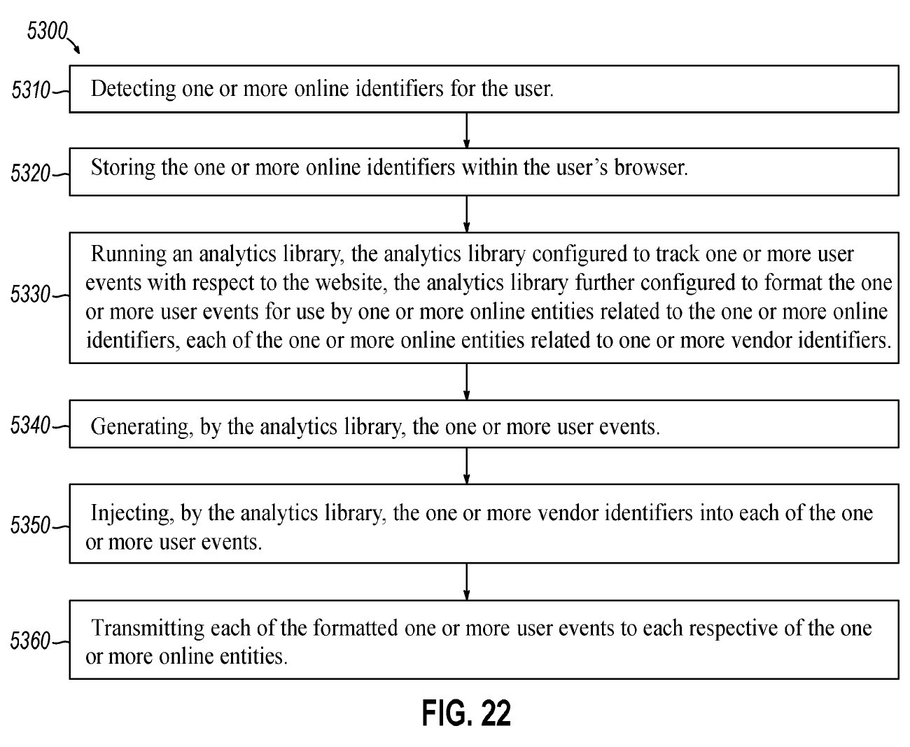

FIG. 22 illustrates another possible method embodiment under the present disclosure. Method 5300 is a computer implemented method for tracking user behavior at a website. Step 5310 is detecting one or more online identifiers for the user. Step 5320 is storing the one or more online identifiers within the user’s browser. Step 5330 is running an analytics library, the analytics library configured to track one or more user events with respect to the website, the analytics library further configured to format the one or more user events for use by one or more online entities related to the one or more online identifiers, each of the one or more online entities related to one or more vendor identifiers. Step 5340 is generating, by the analytics library, the one or more user events. Step 5350 is injecting, by the analytics library, the one or more vendor identifiers into each of the one or more user events. Step 5360 is transmitting each of the formatted one or more user events to each respective of the one or more online entities. Method 5300 can comprise various additional, alternative or optional steps or other variations.

### Website Delivery Embodiments

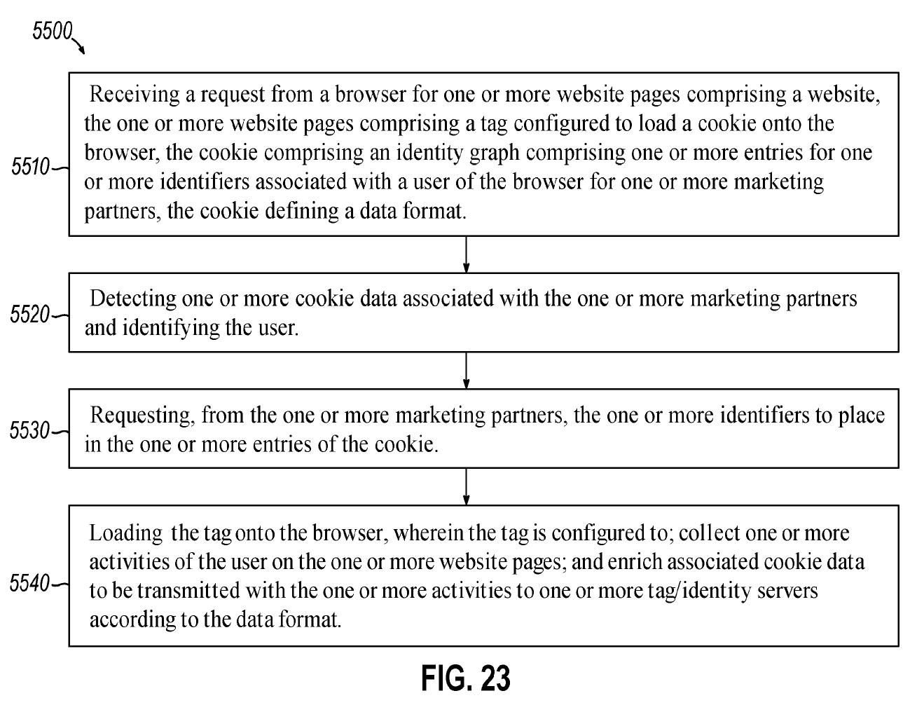

FIG. 23 illustrates a possible method embodiment under the present disclosure. Method 5500 is a method performed by one or more web servers for providing a website to users. Step 5510 is receiving a request from a browser for one or more website pages comprising a website, the one or more website pages comprising a tag configured to load a cookie onto the browser, the cookie comprising an identity graph comprising one or more entries for one or more identifiers associated with a user of the browser for one or more marketing partners, the cookie defining a data format. Step 5520 is detecting one or more cookie data associated with the one or more marketing partners and identifying the user. Step 5530 is requesting, from the one or more marketing partners, the one or more identifiers to place in the one or more entries of the cookie. Step 5540 is loading the tag onto the browser, wherein the tag is configured to; collect one or more activities of the user on the one or more website pages; and enrich associated cookie data to be transmitted with the one or more activities to one or more tag/identity servers according to the data format. Method 5500 can comprise various additional, alternative or optional steps or other variations.

### Computing Devices

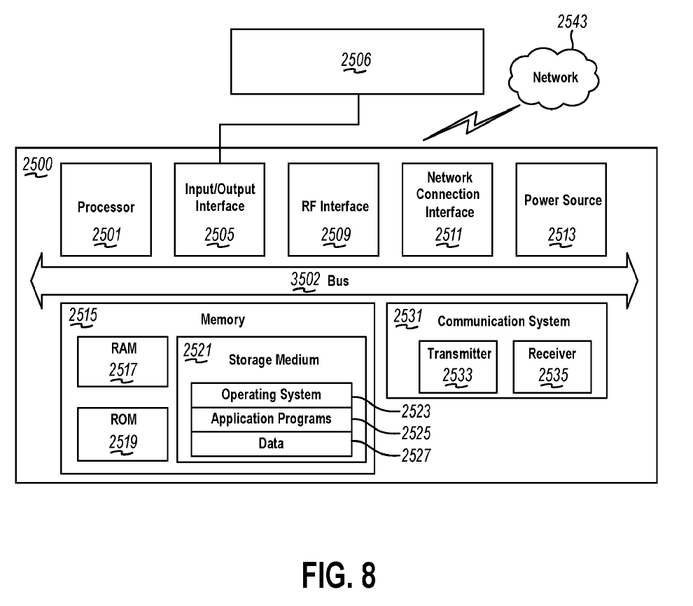

FIG. 8 shows a schematic block diagram of a computing device 2500 (or components thereof) according to certain embodiments of the present disclosure. Computing device 2500 can comprise portions or more of e.g., user devices 310, 315, website server(s) 330, tracking server(s) 340, tag/identity system 350, and/or tag/identity server 360 or other types of computing devices as described further below in other embodiments. Computing device 2500 may comprise computers, smartphones, tablets, servers, databases, other computing devices, and/or combinations of the foregoing. Components of computing device 2500 could in some embodiments be distributed across multiple physical hardware components or locations. Computing device 2500 may be configured to perform a variety of functionalities and/or methods described herein, including the functionalities described or illustrated with respect to FIGS. 1-5 and other figures and embodiments described below.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. Certain computing devices 2500 may utilize all or a subset of the components shown in e.g., FIG. 8 or other figures. The level of integration between the components may vary from one embodiment to another. Further, certain computing device 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide an interface or interfaces to an input device, output device, or one or more input and/or output devices, such as screen 2506. Examples of an output device include a speaker, a sound card, a video card, a display, a monitor, a printer, an actuator, an emitter, a smartcard, another output device, or any combination thereof. An input device may allow a user to capture information into computing device 2500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random-access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Although the computing devices described herein (e.g., servers, computers, databases, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A computer implemented method (2700) of managing one or more tracking tools in a browser (310, 315), comprising:
receiving (2710), at a website server (330, 340), a request from a browser for one or more website pages comprising the website, the one or more website pages comprising a tag (336) configured to load a cookie onto the browser, the cookie comprising an identity graph comprising one or more entries for one or more identifiers associated with a user of the browser for one or more marketing partners, the cookie defining a data format;
detecting (2720), by the tag, one or more cookie data associated with the one or more marketing partners and identifying the user;
requesting (2730), from the one or more marketing partners, the one or more identifiers to place in the one or more entries of the cookie,
loading (2740), by the website server, the cookie onto the browser;
collecting (2750), by the cookie, one or more activities of the user on the one or more website pages;
transmitting (2760) the one or more activities, enriched with the previously collected identity graph stored as cookies, to one or more identity servers according to the data format;
associating (2770), by the one or more identity servers (360), the one or more activities with an event format associated with each of the one or more marketing partners; and
forwarding (2780) the one or more activities to the one or more marketing partners according to the respective event format.

2. The method of claim 1, further comprising monitoring the transmitting and the requesting for one or more metrics.

3. The method of claim 1, wherein the one or more activities comprise at least one of: page visits; purchase amount; clicks; videos watched; advertisements clicked on.

4. The method of claim 1, wherein the one or more marketing partners comprise at least one of: Twitter/X; Google; Facebook; Meta; Pinterest.

5. The method of claim 1, wherein at least one of the one or more identifiers comprises personally identifying information (PII).

6. The method of claim 1, further comprising:
receiving (4510), from a client user, identification of one or more consent categories;
presenting (4520), to the user, the one or more consent categories;
receiving (4530), from the user, one or more preferences for the one or more consent categories; and
combining (4550) the one or more preferences to the one or more activities.

7. The method of claim 1, further comprising:
receiving (4710) one or more preferences of the user related to tracking data;
storing (4720) the one or more preferences in the browser;
configuring (4730) whether implicit mode or explicit mode is applicable to the website’s compliance settings;
if implicit mode is applicable, then performing the steps of;
executing (4740) syncs unless the browsing user opts out of tracking one or more categories; and
if a browsing user has opted out of a category, then not executing (4750) the sync; and
if explicit mode is applicable, then performing the steps of;
only executing syncs (4760) once the browsing user opts in to tracking one or more categories; and
if a browsing user has opted out of a category, then not executing (4770) the sync.

8. The method of claim 1, further comprising:
associating (4920) the one or more identifiers with one or more domain name system (DNS) addresses associated with the one or more marketing partners;
sending (4930) a request, to the one or more DNS addresses, for additional data related to the one or more identifiers;
receiving (4940) the additional data; and
combining (4950) the additional data with the one or more identifiers.

9. A computer implemented method (4100) of creating one or more tracking tools for use in an internet browser (310, 315), comprising:
receiving (4110), from a client user, identification of one or more consent categories;
receiving (4120), from the client user, identification of one or more domains for cross-domain syncing;
receiving (4130), from the client user, one or more secure personally identifying information (PII) configurations;
receiving (4140), from the client user, identification of one or more sync injector templates for use in the client user’s website;
receiving (4150), from the client user, one or more sync-specific configurations to apply to the one or more sync injector templates;
compiling (4160) the one or more sync-specific configurations, the one or more consent categories, the one or more domains, and the one or more secure PII configurations to the one or more sync injector template to create a respective one or more compiled sync injectors;
storing (4170) the one or more compiled sync injectors in one or more libraries; and
transmitting (4180) the one or more compiled sync injectors to one or more website servers (330, 340).

10. The method of claim 9, wherein the one or more compiled sync injectors are configured to inject a tag into the internet browser when a user visits the one or more website servers.

11. The method of claim 9, wherein the one or more domains comprise one or more marketing partners of the client user.

12. The method of claim 11, wherein the one or more marketing partners comprise one or more of: Twitter/X; Google; Facebook; Meta; Pinterest.

13. The method of claim 9, further comprising receiving one or more activities of the internet browser tracked by the one or more compiled sync injectors when a user visits the one or more website servers.

14. The method of claim 13, further comprising sending the one or more activities to the one or more domains in a predetermined format for each of the one or more domains.

15. A computer implemented method (4500) for enforcing user consent preferences related to one or more tracking tools (336) for use in an internet browser (310, 315), comprising:
receiving (4510), from a client user, identification of one or more consent categories;
presenting (4520), to a browsing user, the one or more consent categories;
receiving (4530), from the browsing user, one or more preferences for the one or more consent categories;
tracking (4540) one or more browser events related to activity of the browsing user on a website (332);
combining (4550) the one or more preferences to the one or more browser events.

16. The method of claim 15, further comprising:
receiving (4710) one or more preferences of a browsing user related to tracking data;
storing (4720) the one or more preferences in the browser;
configuring (4730) whether implicit mode or explicit mode is applicable to the business’s compliance settings; if implicit mode is applicable, then performing the steps of;
executing (4740) a sync related to the one or more tracking tools unless the browsing user opts out of tracking one or more categories; and
if a browsing user has opted out of a category, then not executing (4750) the sync; and
if explicit mode is applicable, then performing the steps of;
only executing the sync (4760) once the browsing user opts in to tracking one or more categories; and
if a browsing user has opted out of a category, then not executing (4770) the sync.

17. The method of claim 15, wherein the one or more tracking tools comprise a compiled sync injector comprising: one or more sync-specific configurations; one or more consent categories; one or more domains; and one or more secure personally identifying information (PII) configurations.

18. The method of claim 15, further comprising:
collecting (4910) one or more user identifications, each of the one or more user identifications identifying the browsing user with respect to one or more online services;
associating (4920) the one or more user identifications with one or more domain name system (DNS) addresses associated with the one or more online services;
sending (4930) a request, to the one or more DNS addresses, for additional data related to the one or more user identifications;
receiving (4940) the additional data; and
combining (4950) the additional data with the one or more user identifications.

19. The method of claim 15, further comprising:
detecting (5110) one or more user identifications of the user;
transmitting (5120) a request to a secure endpoint for one or more additional data related to the one or more user identifications, the one or more additional data comprising personally identifying information (PII);
receiving (5130) the one or more additional data;
hashing (5140) the one or more additional data; and
combining (5150) the hashed one or more additional data with one or more records of the user’s visit to the website.

20. The method of claim 15, wherein the one or more consent categories comprise categories required under General Data Protection Regulation (GDPR).
